(19) United States
(12) Patent Application Publication
(10) Pub. No.: US 2025/0174630 A1
(43) Pub. Date: May 29, 2025

(54) SOLVENT-LESS CATHODE COMPOSITION AND PROCESS FOR MAKING

(71) Applicant: QUANTUMSCAPE BATTERY, INC., San Jose, CA (US)

(72) Inventors: Rita LIN, San Jose, CA (US); Kelen KOVACS, San Jose, CA (US); Yuki KATOH, San Jose, CA (US)

(21) Appl. No.: 18/851,058

(22) PCT Filed: Apr. 21, 2023
(86) PCT No.: PCT/US2023/019468

§ 371 Date: Sep. 25, 2024

Related U.S. Application Data
(60) Provisional application No. 63/333,501, filed on Apr. 21, 2022.

(51) Int. Cl. H01M 4/1391; H01M 4/02; H01M 4/04; H01M 4/131; H01M 4/505; H01M 4/525; H01M 4/62

(52) U.S. Cl. CPC H01M 4/1391; H01M 4/043; H01M 4/131; H01M 4/505; H01M 4/525; H01M 4/623; H01M 2004/021; H01M 2004/028

(57) ABSTRACT

Provided herein are solid-state cathode compositions and processes for making solid-state cathode compositions.

### CROSS-REFERENCE

This application claims the benefit of, and priority to, U.S. Provisional Application No. 63/333,501 (filed Apr. 21, 2022), the entire contents of which are incorporated by reference in their entirety for all purposes.

### FIELD

The present disclosure concerns rechargeable lithium batteries and electrodes (e.g., cathodes) used in these batteries as well as methods of preparing batteries and electrodes.

### BACKGROUND

Solid-state cathodes are advantageous for safety reasons and energy density reasons. However, solid-state cathodes are difficult to process.

One processing challenge is the amount of solvent used to make a cathode. Another challenge is the method of mixing the active material to provide the most desirable properties, such as the degree of fibrillization in the cathode active material.

What are needed are processes that can form cathodes with good fibrillization without using substantial amounts of solvents. Set forth herein are solutions to this problem as well as others in the field to which the instant disclosure pertains.

### SUMMARY

In one embodiment, set forth herein is a process for making a solid-state cathode (SSC) sheet, comprising providing, or having provided, a solvent-free mixture comprising cathode active material particles, a catholyte, and binder particles; wherein the binder particles are present at 1% w/w or less; dough-kneading the mixture to form binder fibrils; and depositing the mixture to form an SSC sheet.

In a second embodiment, set forth herein is a process a process for making a solid-state cathode (SSC) sheet, comprising: providing, or having provided, a solvent-free mixture comprising cathode active material particles, a catholyte, and binder particles; wherein the binder particles are present at 5 percent by weight (w/w) or less; maintaining the mixture at a temperature from about −30°° C. to −5° C.; dough-kneading the mixture to form binder fibrils at a temperature from about 25° C. to 200° C.; and depositing the mixture to form an SSC sheet; thereby providing an SSC sheet. In some of these embodiments, the process further comprises mixing the cathode active material particles, a catholyte, and binder particles before maintaining the mixture. In some of these embodiments, the process comprises mixing the mixture while maintaining the mixture at the temperature from about −30° C. to −5° C.

In a third embodiment, set forth herein is a composition comprising: cathode active material particles; a binder present at 1% w/w or less; wherein the binder is mixed with the cathode active material particles; the binder is present as fibrils; and the composition is solvent-free.

In a fourth embodiments, the composition as otherwise set forth herein is prepared by a process including stabilization of the binder mixture and dough-kneading the cathode active material at an elevated temperature. In some embodiments, kneading is performed at a temperature from 35° C. to 200° C. In some embodiments, kneading is performed at a temperature from 35° C. to 100° C.

### BRIEF DESCRIPTIONS OF THE DRAWINGS

FIG. 1 shows an embodiment of a process for making a solid-state cathode.

FIG. 2 shows an embodiment of a process for making a solid-state cathode.

FIG. 3 is a Differential Scanning calorimetry (DSC) plot of a solid-state cathode.

FIG. 4 is a plot of Voltage (V) vs. cycle active mass-specific capacity (mAh/g).

FIG. 5 is a plot of Area-specific Resistance (ASR) vs. Pulse Index.

FIG. 6 is a plot of tensile strength (stress in kPA) vs. strain.

FIG. 7 is a plot of sheet Young's modulus (GPa) vs. sheet tensile strength (mPa) for some comparative examples.

FIG. 8 is a plot of sheet plastic elongation (%) vs. sheet tensile strength (mPa) for some comparative examples.

### DETAILED DESCRIPTION

### Definitions

As used herein, the term “about,” when qualifying a number, e.g., about 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well as 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrase “cathode active material” refers to a material which can intercalate lithium ions or react with lithium ions in a reversible manner. Examples include LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al₂O₂, wherein x+y+z=1, and 0≤x≤1, 0≤y≤1, and 0Sz≤1. In these formula, x, y, and z are chosen so that the formula is charge neutral.

As used herein, the phrase “solid-state cathode” refers to a cathode which does not include any liquid-phase electrolytes. As used herein, the terms “cathode” and “anode” refer to the electrodes of a battery. The cathode and anode are often referred to in the relevant field as the positive electrode and negative electrode, respectively. During a charge cycle in a Li-secondary battery, Li ions leave the cathode and move through an electrolyte, to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode. As used herein, the phrase “positive electrode” refers to the electrode in a secondary battery towards which positive ions, e.g., Li⁺, conduct, flow or move during discharge of the battery. As used herein, the phrase “negative electrode” refers to the electrode in a secondary battery from where positive ions, e.g., Li⁺, flow or move during discharge of the battery. In a battery comprised of a Li-metal electrode and a conversion chemistry, intercalation chemistry, or combination conversion/intercalation chemistry-including electrode (i.e., cathode active material; e.g., NiFₓ, NCA, LiNiₓMn_{y}CO_{z}O₂ [NMC] or LiNiₓAl_{y}Co_{z}O₂ [NCA], wherein x+y+z=1), the electrode having the conversion chemistry, intercalation chemistry, or combination conversion/intercalation chemistry material is referred to as the positive electrode. In some usages, cathode is used in place of positive electrode, and anode is used in place of negative electrode. When a Li-secondary battery is charged, Li ions move from the positive electrode (e.g., NiFₓ, NMC, NCA) towards the negative electrode (e.g., Li-metal). When a Li-secondary battery is discharged, Li ions move towards the positive electrode and from the negative electrode.

As used herein, the phrase “solid separator” refers to a Li⁺ ion-conducting material that is substantially insulating to electrons (e.g., the lithium ion conductivity is at least 10³ times, and often 10⁶ times, greater than the electron conductivity), and which acts as a physical barrier or spacer between the positive and negative electrodes in an electrochemical cell.

As used herein, “LSTPS” refers to a material characterized by the formula LiₐMP_{b}S_{c}, where Mis Si, Ge, Sn, and/or Al, and where 2≤a≤8, 0.5≤b≤2.5, 4≤c≤12. “LSPS” refers to an electrolyte material characterized by the formula LaSiPbSc, where 2≤a≤8, 0.5≤b≤2.5, 4≤c≤12. LSPS refers to an electrolyte material characterized by the formula LaSiPbSc, wherein, where 23a≤8, 0.5≤b≤2.5, 4 <c≤12, d<3. Exemplary LSTPS materials are found, for example, in International Patent Application No. PCT/US14/38283, SOLID STATE CATHOLYTE OR ELECTROLYTE FOR BATTERY USING Li_{A}MP_{B}S_{C} (M=SI, GE, AND/OR SN), filed May 15, 2014, and published as WO 2014/186634, on Nov. 20, 2014, which is incorporated by reference herein in its entirety. Exemplary LSTPS materials are found, for example, in U.S. patent application Ser. No. 14/618,979, filed Feb. 10, 2015, and published as Patent Application Publication No. 2015/0171465, on Jun. 18, 2015, which is incorporated by reference herein in its entirety. When M is Sn and Si—both are present. As used herein, “LSTPSO” refers to LSTPS that is doped with, or has, O present. In one embodiment, “LSTPSO” is a LSTPS material with an oxygen content between 0.01 and 10 atomic %. “LSPS” refers to an electrolyte material having Li, Si, P, and S chemical constituents. As used herein “LSTPS” refers to an electrolyte material having Li, Si, P, Sn, and S chemical constituents. As used herein, “LSPSO” refers to LSPS that is doped with, or has, O present. In one embodiment, “LSPSO” is a LSPS material with an oxygen content between 0.01 and 10 atomic %. As used herein, “LATP,” refers to an electrolyte material having Li, As, Sn, and P chemical constituents. As used herein “LAGP” refers to an electrolyte material having Li, As, Ge, and P chemical constituents. As used herein, “LSTPSO” refers to a catholyte material characterized by the formula LiₐMP_{b}S_{c}O_{d}, where M is Si, Ge, Sn, and/or Al, and where 2≤a≤8, 0.5≤b≤2.5, 4≤c≤12, d<3. LSTPSO refers to LSTPS, as defined above, and having oxygen doping at from 0.1 to about 10 atomic %. LPSO refers to LPS, as defined above, and having oxygen doping at from 0.1 to about 10 atomic %.

As used herein, area-specific resistance (ASR) is measured by electrochemical cycling using an Arbin or Biologic instrument unless otherwise specified to the contrary.

As used herein, ionic conductivity is measured by electrical impedance spectroscopy methods known in the art.

As used herein, the term “electrolyte” refers to an ionically conductive and electrically insulating material. Electrolytes are useful for electrically insulating the positive and negative electrodes of a rechargeable battery while allowing for the conduction of ions, e.g., Li⁺, through the electrolyte.

As used herein, the phrase “film” or “thin film” refers to a thin membrane of less than 1.0 mm in thickness and greater than 100 nm in thickness. A thin film is also greater than 5 mm in a lateral dimension. A “film” or “thin-film” may be produced by a continuous process such as tape-casting, slip casting, or screen-printing.

As used herein, the phrase “film thickness” refers to the distance, or median measured distance, between the top and bottom faces of a film. As used herein, the top and bottom faces refer to the sides of the film having the largest surface area. As used herein, thickness is measured by cross-sectional scanning electron microscopy.

As used herein, “thin” when used with regard to a solid-state cathode (SSC) sheet refers to a sheet or film having an average cross-sectional thickness of less than 1.0 mm and greater than 20 μm. In some embodiments, a thin SSC is an SSC sheet that is 50 μm to 500 μm in thickness. In some embodiments, a thin SSC is an SSC sheet that is 10 μm to 300 μm in thickness. In some embodiments, a thin SSC is an SSC sheet that is 100 μm to 150 μm in thickness. In some embodiments, a thin SSC is an SSC sheet that is 100 μm to 120 μm in thickness. In some embodiments, a thin SSC is an SSC sheet that is 80 μm to 100 μm in thickness.

As used herein, “binder” refers to a polymer with the capability to increase the adhesion and/or cohesion of material, such as the solids in a green tape. Suitable binders may include, but are not limited to, PVDF, PVDF-HFP, SBR, and ethylene alpha-olefin copolymer. A “binder” refers to a material that assists in the adhesion of another material. For example, as used herein, polyvinyl butyral is a binder because it is useful for adhering garnet materials. Other binders may include polycarbonates. Other binders may include poly acrylates and poly methacrylates. These examples of binders are not limiting as to the entire scope of binders contemplated here but merely serve as examples. Binders useful in the present disclosure include, but are not limited to, polypropylene (PP), polyethylene, atactic polypropylene (aPP), isotactic polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), polyethylene-co-poly (methylene cyclopentane) (PE-co-PMCP), poly (methyl methacrylate) (and other acrylics), acrylic, polyvinylacetacetal resin, polyvinyl butyral resin, PVB, polyvinyl acetal resin, stereoblock polypropylenes, polypropylene polymethylpentene copolymer, polyethylene oxide (PEO), PEO block copolymers, silicone, and the like. In some examples, including any of the foregoing, the binder is a polymer is selected from the group consisting of polyacrylonitrile (PAN), polypropylene, polyethylene, polyethylene oxide (PEO), poly methyl methacrylate (PMMA), polyvinyl chloride (PVC), polyvinyl pyrrolidone (PVP), polyethylene oxide poly (allyl glycidyl ether) PEO-AGE, polyethylene oxide 2-methoxy ethoxy ethyl glycidyl ether (PEO-MEEGE), polyethylene oxide 2-methoxyethoxyethyl glycidyl poly (allyl glycidyl ether) (PEO-MEEGE-AGE), polysiloxane, polyvinylidene fluoride (PVDF), polyvinylidene fluoride hexafluoropropylene (PVDF-HFP), ethylene propylene (EPR), nitrile rubber (NPR), styrene-butadiene-rubber (SBR), polybutadiene polymer, polybutadiene rubber (PB), polyisobutadiene rubber (PIB), polyolefin, alpha-polyolefin, ethylene alpha-polyolefin, polyisoprene rubber (PI), polychloroprene rubber (CR), acrylonitrile-butadiene rubber (NBR), and polyethyl acrylate (PEA).

As used herein, the term “electrolyte” refers to an ionically conductive and electrically insulating material. Electrolytes are useful for electrically insulating the positive and negative electrodes of a rechargeable battery while allowing for the conduction of ions, e.g., Li+, through the electrolyte. In some of the electrochemical devices described herein, the electrolyte includes a solid-state film, pellet, or monolith of a Li+ conducting oxide, such as a lithium-stuffed garnet. In some examples, the electrolyte further includes a gel electrolyte which is laminated to or directly contacting the solid film, pellet, or monolith.

As used herein, “solid-state thin film or pellet separator” refers to the solid-state electrolyte which may be present as a thin film, or a pressed-powder pellet. The thin film or pellet may comprise sintered or unsintered Li+ conducting oxide, such as a lithium-stuffed garnet.

As used herein, the term “solid-state electrolyte,” refers to an electrolyte, as defined herein, wherein the electrolyte is a solid.

As used herein, the terms “separator,” and “Li+ ion-conducting separator,” are used interchangeably with separator being a short-hand reference for Li+ ion-conducting separator, unless specified otherwise explicitly. A separator refers to a solid-state electrolyte which conducts Li+ ions, is substantially insulating to electrons, and is suitable for use as a physical barrier or spacer between the positive and negative electrodes in an electrochemical cell or a rechargeable battery. A separator, as used herein, is substantially insulating to electrons. A separator's lithium ion conductivity is at least 103 times, and typically 106 times, greater than the separator's electron conductivity.

As used herein, the phrase “lithium-stuffed garnet” refers to oxides that are characterized by a crystal structure related to a garnet crystal structure. Lithium-stuffed garnets include compounds having the formula Li_{A}La_{B}Zr_{C}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5,1.5<B<4,0<C<2,0<D<2;0<E<2.5,10<F<13, and M′ and M″ are each, independently in each instance selected from Al, Mo, W, Nb, Ga, Sb, Ca, Ba, Sr, Ce, Hf, Rb, and Ta; or LiₐLa_{b}Zr_{c}Al_{d}Me″ₑO_{f}, wherein 5<a<7.7; 2<b<4; 0<c≤2.5; 0<d<2; 0<e<2, 10<f<13 and Me″ is a metal selected from Nb, V, W, Mo, Ta, Ga, and Sb. Garnets, as used herein, also include those garnets described above that are doped with Al or Al₂O₃. Also, garnets as used herein include, but are not limited to, Li_{A}La_{B}Zr_{C}O_{F}+yAl₂O₃, wherein x may be from 5.8 to 7.0, and y may be 0. 1, 0.2, 0.3, 0.4, 0.5, 0.6, 0.7, 0.8, 0.9, or 1.0; and wherein 4<A<8.5, 1.5<B<4, 0<C≤2, 0<D<2; 10<F<13. Also, garnets as used herein include, but are not limited to, LiₓLa₃Zr₂O₁₂+yAl₂O₃, wherein x may be from 5.8 to 7.0, and y may be 0. 1, 0.2, 0.3, 0.4, 0.5, 0.6, 0.7, 0.8, 0.9, or 1.0. As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂ (SiO₄) 3 wherein X is Ca, Mg, Fe, and, or, Mn; and Y is Al, Fe, and, or, Cr.

As used herein, the phrase “garnet precursor chemicals” or “chemical precursor to a Garnet-type electrolyte” refers to chemicals which react to form a lithium-stuffed garnet material described herein. These chemical precursors include, but are not limited to lithium hydroxide (e.g., LiOH), lithium oxide (e.g., Li₂O), lithium carbonate (e.g., Li₂CO₃), zirconium oxide (e.g., ZrO₂), lanthanum oxide (e.g., La₂O₃), aluminum oxide (e.g., Al₂O₃), aluminum (e.g., Al), aluminum nitrate (e.g., AlNO₃), aluminum nitrate nonahydrate, niobium oxide (e.g., Nb₂O₅), tantalum oxide (e.g., Ta₂O₅).

As used herein, the phrase “d₅₀ diameter” refers to the median size, in a distribution of sizes, measured by microscopy techniques or other particle size analysis techniques, such as, but not limited to, scanning electron microscopy or dynamic light scattering. D₅₀ includes the characteristic dimension at which 50% of the particles are smaller than the recited size.

As used herein, the phrase “d90 diameter” refers to a size, in a distribution of sizes, measured by microscopy techniques or other particle size analysis techniques, such as, but not limited to, scanning electron microscopy or dynamic light scattering. D90 includes the characteristic dimension at which 90% of the particles are smaller than the recited size.

As used herein, the term “catholyte” refers to a liquid or gel electrolyte confined within the positive electrode space of an electrochemical cell. Catholyte also refers to a Li ion conductor that is intimately mixed with, or that surrounds and contacts, or that contacts the positive electrode active materials and provides an ionic pathway for Li+ to and from the active materials. Catholytes may also be liquid, gel, semi-liquid, semi-solid, polymer, and/or solid polymer ion conductors. In some examples, the catholyte includes a gel set forth herein. In some examples, the gel electrolyte includes any electrolyte set forth herein, including a nitrile, dinitrile, organic sulfur-including solvent, or combination thereof set forth herein.

### Compositions

Set forth herein is a composition comprising: cathode active material particles; a binder present at 1% w/w or less (e.g., 1, 0.95, 0.9, 0.85. 0.8, 0.75, 0.7, 0.65, 0.6, 0.55, 0.5, 0.45, 0.4, 0.35, 0.3, 0.25, 0.2, 0.15, or 0.1%); wherein: the binder is mixed with the cathode active material particles; the binder is present as fibrils; and the composition is solvent-free.

In some embodiments, including any of the foregoing, the binder is present at 0.3% w/w or less (e.g., 0.25, 0.20, 0.15, 0.10, 0.075, or 0.05%).

In some embodiments, including any of the foregoing, the binder is poly (tetrafluoroethylene) (PTFE).

In some embodiments, including any of the foregoing, the binder is PTFE or poly (vinylpyrrolidone) (PVP).

In some embodiments, including any of the foregoing, the PTFE binder particle size is <2 mm. In some embodiments, including any of the foregoing, the PTFE binder particle size is <1.5 mm. In some embodiments, including any of the foregoing, the PTFE binder particle size is <1 mm. In some embodiments, including any of the foregoing, the PTFE binder particle size is <0.75 mm. In some embodiments, including any of the foregoing, the PTFE binder particle size is <0.5 mm.

In some embodiments, including any of the foregoing, the binder is PTFE and at least one additional binder.

In some embodiments, including any of the foregoing, the binder is PTFE and at least one additional binder selected from polyvinylidene fluoride (PVDF), polyvinylidene fluoride hexafluoropropylene (PVDF-HFP), ethylene propylene (EPR), nitrile rubber (NPR), styrene-butadiene-rubber (SBR), polypropylene (PP), polyethylene, atactic polypropylene (aPP), isotactic polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), polyethylene-co-poly (methylene cyclopentane) (PE-co-PMCP), poly (methyl methacrylate) (PMMA) (and other acrylics), acrylic, polyvinylacetacetal resin, polyvinyl butyral resin, PVB, polyvinyl acetal resin, stereoblock polypropylenes, polypropylene polymethylpentene copolymer, polyethylene oxide (PEO), PEO block copolymers, silicone, polyacrylonitrile (PAN), polyvinyl chloride (PVC), polyvinyl pyrrolidone (PVP), polyethylene oxide poly (allyl glycidyl ether) PEO-AGE, polyethylene oxide 2-methoxy ethoxy ethyl glycidyl ether (PEO-MEEGE), polyethylene oxide 2-methoxyethoxyethyl glycidyl poly (allyl glycidyl ether) (PEO-MEEGE-AGE), polysiloxane, polybutadiene polymer, polybutadiene rubber (PB), polyisobutadiene rubber (PIB), polyolefin, alpha-polyolefin, ethylene alpha-polyolefin, polyisoprene rubber (PI), polychloroprene rubber (CR), acrylonitrile-butadiene rubber (NBR), polyethyl acrylate (PEA), and combinations thereof.

In some embodiments, including any of the foregoing, the cathode active material is a material set forth in International Patent Application Publication No. PCT/US2021/049528, filed Sep. 8, 2021, and titled CATHODE COATING, the entire contents of which are herein incorporated by reference in its entirety for all purposes.

In some embodiments, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNixMnyCo2O₂, x+y+z=1, 05x≤1, 0≤y≤1, and 0≤z≤1; and LiNiₓCo_{y}Al₂O₂, wherein x+y+z=1, and 0≤x≤1, 0≤y≤1, and 0≤z≤1.

In some embodiments, including any of the foregoing, the cathode active material is LiNiₓMn_{y}Co_{z}O₂, x+y+z=1, 0≤x≤1, 0≤y≤1, and 0≤z≤1 and wherein x+y+z=1.

In some embodiments, including any of the foregoing, the cathode active material is LiNiₓMn_{y}Co_{z}O₂, x is 0.8, y is 0.1, and z is 0.1.

In some embodiments, including any of the foregoing, the cathode active material is LiNiₓMn_{y}Co_{z}O₂, x is 0.6, y is 0.2, and z is 0.2.

In some embodiments, including any of the foregoing, the cathode active material is LiNiₓMn_{y}Co_{z}O₂, x is 0.5, y is 0.3, and z is 0.2.

In some embodiments, including any of the foregoing, the cathode active material is LiNiₓMn_{y}Co_{z}O₂, x is 1/3, y is 1/3, and z is 1/3.

In some embodiments, including any of the foregoing, the cathode active material is Li(NiCoMn)O₂.

In some embodiments, including any of the foregoing, the cathode active material is LiFePO₄.

In some embodiments, including any of the foregoing, the NMC has a d50 particle size, S, of 0.1 μm<S<50 μm.

In some embodiments, including any of the foregoing, the NMC has a d50 particle size, S, of 0.5 μm<S<30 μm.

In some embodiments, including any of the foregoing, the NMC has a d50 particle size, S, of 1 μm<S<20 μm.

In some embodiments, including any of the foregoing, the NMC has a d50 particle size, S, of 2 μm<S<15 μm.

In some embodiments, including any of the foregoing, the NMC has a d50 particle size, S, of 3 μm<S<12 μm.

In some embodiments, including any of the foregoing, the NMC has a d50 particle size, S, of 4 μm<S<10 μm.

In some embodiments, including any of the foregoing, the catholyte has a d50 particle size, T, of 0.005 μm<T<20 μm.

In some embodiments, including any of the foregoing, the catholyte has a d50 particle size, T, of 0.01 μm<T<10 μm.

In some embodiments, including any of the foregoing, the catholyte has a d50 particle size, T, of 0.02 μm<T<10 μm.

In some embodiments, including any of the foregoing, the catholyte has a d50 particle size, T, of 0.05 μm<T<8 μm.

In some embodiments, including any of the foregoing, the catholyte has a d50 particle size, T, of 0.02 μm<T<5 μm.

In some embodiments, including any of the foregoing, the catholyte has a d50 particle size, T, of 0.05 μm<T<3 μm.

In some embodiments, including any of the foregoing, the catholyte has a d50 particle size, T, of 0.1 μm<T<1.5 μm.

In some embodiments, including any of the foregoing, the composition has a density of 2-2.5g/cm³ (e.g., about 1.8, 1.9, 2.0, 2.1, 2.2, 2.3, 2.4, 2.5, or 2.6).

In some embodiments, including any of the foregoing, set forth herein is a thin sheet comprising a composition set forth herein.

In some embodiments, including any of the foregoing, the catholyte is LSTPS.

In some embodiments, including any of the foregoing, the catholyte is argyrodite.

In some embodiments, including any of the foregoing, the catholyte is a lithium ion conducting sulfide, e.g., Li₂S-SiS₂.

In some embodiments, including any of the foregoing, the catholyte is a lithium ion conducting oxide, e.g., lithium-stuffed garnet.

In some embodiments, including any of the foregoing, the catholyte is a lithium ion conducting halide, e.g., perovskite.

In some embodiments, including any of the foregoing, the catholyte is a lithium ion conducting organic polymer, e.g., LiPF₆ in PEO.

In some embodiments, including any of the foregoing, the cathode active loading in the cathode is between 1 and 15 mAh/cm².

In some embodiments, including any of the foregoing, the cathode active loading is between at least 5 mAh/cm².

In some embodiments, including any of the foregoing, the sheet has a thickness of 120 μm.

In some embodiments, including any of the foregoing, the sheet has a thickness of 150 μm.

In some embodiments, including any of the foregoing, the sheet is at least 5 centimeter (cm) in width.

In some embodiments, including any of the foregoing, the sheet is at least 1 meter (m) in width.

In some embodiments, including any of the foregoing, the sheet is at least 10 cm in length.

In some embodiments, including any of the foregoing, the sheet is at least 70 cm in length.

In some embodiments, including any of the foregoing, the sheet is 100 mm×2,000 mm.

In some embodiments, including any of the foregoing, the sheet is at 150 mm×100 m.

In some embodiments, including any of the foregoing, the sheet is at 300 mm×a continuous roll.

In some embodiments, including any of the foregoing, the sheet is at least 1 m in length.

In some embodiments, including any of the foregoing, set forth herein is a bilayer comprising a metal layer in contact with two thin sheets set forth herein.

In some embodiments, including any of the foregoing, set forth herein is a trilayer comprising a metal layer between and in contact with two thin sheets set forth herein.

In some embodiments, including any of the foregoing, the metal layer is a layer of Al.

In some embodiments, including any of the foregoing, the metal layer is a layer of Ni.

In some embodiments, including any of the foregoing, the electrode before des has aa porosity range of 40% to 50% (e.g., about 35, 40, 45, 50, or 55% porosity).

In some embodiments, including any of the foregoing, the electrode product has a tensile strength is from about 0.3 to 0.5 MPa (e.g., 0.28, 0.3, 0.33, 0.35, 0.38, 0.4, 0.43, 0.45, 0.48, 0.5, 0.53, or 0.55 MPa).

In some embodiments, including any of the foregoing, the electrode product has a Young's modulus is from about 0.5 to 0.8 MPa (e.g., 0.48, 0.5, 0.53, 0.55, 0.58, 0.6, 0.63, 0.65, 0.68, 0.7, 0.73, 0.75, 0.78, 0.8, 0.83, or 0.85 MPa).

In some embodiments, including any of the foregoing, the electrode product has a plastic elongation of from about 5 to 15% (e.g., about 5, 6, 7, 8, 9, 10, 11, 12, 13, 14, or 15%).

In some embodiments, including any of the foregoing, the electrode product has an elasticity of from about 0.01 to 0.15 GPa (e.g., about 0.01, 0.02, 0.03, 0.04, 0.05, 0.06, 0.07, 0.08, 0.09, 0.10, 0.11, 0.12, 0.13, 0.14, or 0.15%).

In some embodiments, the composition as otherwise set forth herein is prepared by a process including dough-kneading the cathode active material at a low temperature (i.e., “cold kneading”).

In some embodiments, the composition as otherwise set forth herein is prepared by a process including stabilizing the binder at low temperature and dough-kneading the cathode active material at a higher temperature. In some embodiments, such kneading is performed at a temperature from 25° C. to 200° C. (e.g., 45° C.).

### Processes

Set forth herein is a process for making a solid-state cathode (SSC) sheet, in which the process includes providing, or having provided, a solvent-free mixture comprising cathode active material particles, a catholyte, and binder particles; wherein the binder particles are present at 1% w/w or less (e.g., 1, 0.95, 0.9, 0.85. 0.8, 0.75, 0.7, 0.65, 0.6, 0.55, 0.5, 0.45, 0.4, 0.35, 0.3, 0.25, 0.2, 0.15, or 0.1%); dough-kneading the mixture to form binder fibrils; and depositing the mixture to form an SSC sheet.

In some embodiments, including any of the foregoing, set forth herein is a process for making a solid-state cathode (SSC) sheet, comprising: providing, or having provided, a solvent-free mixture comprising cathode active material particles, a catholyte, and binder particles; wherein the binder particles are present at 5% w/w or less; maintaining the mixture at a temperature from about −30 to −5° C., and dough-kneading the mixture to form binder fibrils at a temperature from about 25 to 200° C.; and depositing the mixture to form an SSC sheet.

In some embodiments, including any of the foregoing, the dough-kneading the mixture to form binder fibrils comprises shearing the cathode active material particles and binder particles to form binder fibrils.

In some embodiments, including any of the foregoing, the dough-kneading the mixture to form binder fibrils further comprises compressing the cathode active material particles and binder particles to create a network of binder fibrils throughout the cathode active material particles.

In some embodiments, including any of the foregoing, the process includes using a roller to press the cathode and cause PTFE fibrils to form and network in the cathode. In some embodiments, the process includes applying a calender press at final stage of the process to densify the cathode.

In some embodiments, including any of the foregoing, the dough-kneading the mixture comprises using a mortar.

In some embodiments, including any of the foregoing, the dough-kneading the mixture comprises using a twin-screw co-rotating extruder. Commercial embodiments of such extruders include, but are not limited to, a Process 11 by Themo Fisher; or the 20MM Twin Screw Mixing Line by Buhler. Other manufactures include Coperion.

In some embodiments, including any of the foregoing, the process further includes preprocessing the binder. For example, preprocessing may include, but is not limited to, atomization of the PTFE powder. One way to atomize the PTFE powder is blade mixing at cold temperature. In some embodiments, the cold temperature is below a phase transition temperature. In certain embodiments, the cold temperature is 10° C. In some embodiments, the cold temperature is below a phase transition temperature. In some embodiments, the cold temperature is at a phase transition temperature. In certain embodiments, the cold temperature is 11° C. In some embodiments, the cold temperature is below a phase transition temperature. In certain embodiments, the cold temperature is 12° C. In some embodiments, the cold temperature is below a phase transition temperature. In certain embodiments, the cold temperature is 13° C. In some embodiments, the cold temperature is below a phase transition temperature. In certain embodiments, the cold temperature is 14° C. In some embodiments, the cold temperature is below a phase transition temperature. In certain embodiments, the cold temperature is 15° C. In some embodiments, the cold temperature is below a phase transition temperature. In certain embodiments, the cold temperature is 16° C. In some embodiments, the cold temperature is below a phase transition temperature. In certain embodiments, the cold temperature is 17° C. In some embodiments, the cold temperature is below a phase transition temperature. In certain embodiments, the cold temperature is 18° C. In certain embodiments, the cold temperature is 19° C. In some embodiments, the cold temperature is below a phase transition temperature. In certain embodiments, the cold temperature is 20° C.

In some embodiments, including any of the foregoing, the process further includes stabilizing the binder. For example, stabilizing may include, but is not limited to, maintaining of the mixture, e.g., at low temperature; and further mixing of the binder (e.g., PTFE) powder, e.g., by blade mixing at cold temperature. In some embodiments, the cold temperature is below a phase transition temperature. In some embodiments, the cold temperature is below a phase transition temperature. In some embodiments, the cold temperature is at a phase transition temperature. In certain embodiments, the cold temperature is from about −40° C. to 0° C. In certain embodiments, the cold temperature is from about −30° C. to −5° C. In certain embodiments, the cold temperature is −30° C. In certain embodiments, the cold temperature is −29° C. In certain embodiments, the cold temperature is −28° C. In certain embodiments, the cold temperature is −27° C. In certain embodiments, the cold temperature is −26° C. In certain embodiments, the cold temperature is −25° C. In certain embodiments, the cold temperature is −24° C. In certain embodiments, the cold temperature is −23° C. In certain embodiments, the cold temperature is −22° C. In certain embodiments, the cold temperature is −21° C. In certain embodiments, the cold temperature is −20° C. In certain embodiments, the cold temperature is −19° C. In certain embodiments, the cold temperature is −18° C. In certain embodiments, the cold temperature is −17° C. In certain embodiments, the cold temperature is −16° C. In certain embodiments, the cold temperature is −15° C. In certain embodiments, the cold temperature is −14° C. In certain embodiments, the cold temperature is −13° C. In certain embodiments, the cold temperature is −12° C. In certain embodiments, the cold temperature is −11° C. In certain embodiments, the cold temperature is −10° C. In certain embodiments, the cold temperature is −9° C. In certain embodiments, the cold temperature is −8° C. In certain embodiments, the cold temperature is −7° C. In certain embodiments, the cold temperature is −6° C. In certain embodiments, the cold temperature is −5° C. In certain embodiments, the cold temperature is −4° C. In certain embodiments, the cold temperature is −3° C. In certain embodiments, the cold temperature is −2° C. In certain embodiments, the cold temperature is −1° C. In certain embodiments, the cold temperature is 0° C.

In some embodiments, stabilizing the binder comprises maintaining the mixture at low temperature for at least one hour. In some embodiments, stabilizing the binder comprises such maintaining for at least 1.5 hours. In some embodiments, stabilizing the binder comprises such maintaining for at least 2 hours. In some embodiments, stabilizing the binder comprises such maintaining for at least 2.5 hours. In some embodiments, stabilizing the binder comprises such maintaining for at least 3 hours. In some embodiments, stabilizing the binder comprises such maintaining for at least 3.5 hours. In some embodiments, stabilizing the binder comprises such maintaining for at least 4 hours. In some embodiments, stabilizing the binder comprises such maintaining for at least 5 hours. In some embodiments, stabilizing the binder comprises such maintaining for at least 6 hours.

In some embodiments, stabilizing the binder comprises further mixing (e.g., by blade mixture). In some embodiments, the mixing is for at least 10× (e.g., 10×2 sec at 20,000 rpm). for at least one hour. In some embodiments, the composition is cooled (e.g., in the low temperature environment) during mixing. In some embodiments, the composition is cooled (e.g., in the low temperature environment) between intervals of mixing.

In some embodiments, including any of the foregoing, the dough-kneading occurs at a temperature of about 18° C. to about 180° C. In some embodiments, the dough-kneading occurs at a temperature of about 50° C. to about 80° C. In some embodiments, the dough-kneading occurs at a temperature of about 60° C. to about 80° C. In some embodiments, the dough-kneading occurs at a temperature of about 70° C. to about 80° C. In some embodiments, the dough-kneading occurs at a temperature of about 80° C. to about 100° C. In some embodiments, the dough-kneading occurs at a temperature of about 90° C. to about 100° C. In some embodiments, the dough-kneading occurs at a temperature of about 18° C. In some embodiments, the dough-kneading occurs at a temperature of about 19° C. In some embodiments, the dough-kneading occurs at a temperature of about 20° C. In some embodiments, the dough-kneading occurs at a temperature of about 21° C. In some embodiments, the dough-kneading occurs at a temperature of about 22° C. In some embodiments, the dough-kneading occurs at a temperature of about 23° C. In some embodiments, the dough-kneading occurs at a temperature of about 24° C. In some embodiments, the dough-kneading occurs at a temperature of about 25° C. In some embodiments, the dough-kneading occurs at a temperature of about 26° C. In some embodiments, the dough-kneading occurs at a temperature of about 27° C. In some embodiments, the dough-kneading occurs at a temperature of about 28° C. In some embodiments, the dough-kneading occurs at a temperature of about 29° C. In some embodiments, the dough-kneading occurs at a temperature of about 30° C. In some embodiments, the dough-kneading occurs at a temperature of about 31° C. In some embodiments, the dough-kneading occurs at a temperature of about 32° C. In some embodiments, the dough-kneading occurs at a temperature of about 33° C. In some embodiments, the dough-kneading occurs at a temperature of about 34° C. In some embodiments, the dough-kneading occurs at a temperature of about 35° C. In some embodiments, the dough-kneading occurs at a temperature of about 36° C. In some embodiments, the dough-kneading occurs at a temperature of about 37° C. In some embodiments, the dough-kneading occurs at a temperature of about 38° C. In some embodiments, the dough-kneading occurs at a temperature of about 39° C. In some embodiments, the dough-kneading occurs at a temperature of about 40° C. In some embodiments, the dough-kneading occurs at a temperature of about 41° C. In some embodiments, the dough-kneading occurs at a temperature of about 42° C. In some embodiments, the dough-kneading occurs at a temperature of about 43° C. In some embodiments, the dough-kneading occurs at a temperature of about 44° C. In some embodiments, the dough-kneading occurs at a temperature of about 45° C. In some embodiments, the dough-kneading occurs at a temperature of about 46° C. In some embodiments, the dough-kneading occurs at a temperature of about 47° C. In some embodiments, the dough-kneading occurs at a temperature of about 48° C. In some embodiments, the dough-kneading occurs at a temperature of about 49° C. In some embodiments, the dough-kneading occurs at a temperature of about 50° C. In some embodiments, the dough-kneading occurs at a temperature of about 51° C. In some embodiments, the dough-kneading occurs at a temperature of about 52° C. In some embodiments, the dough-kneading occurs at a temperature of about 53° C. In some embodiments, the dough-kneading occurs at a temperature of about 54° C. In some embodiments, the dough-kneading occurs at a temperature of about 55° C. In some embodiments, the dough-kneading occurs at a temperature of about 56° C. In some embodiments, the dough-kneading occurs at a temperature of about 57° C. In some embodiments, the dough-kneading occurs at a temperature of about 58° C. In some embodiments, the dough-kneading occurs at a temperature of about 59° C. In some embodiments, the dough-kneading occurs at a temperature of about 60° C. In some embodiments, the dough-kneading occurs at a temperature of about 61° C. In some embodiments, the dough-kneading occurs at a temperature of about 62° C. In some embodiments, the dough-kneading occurs at a temperature of about 63° C. In some embodiments, the dough-kneading occurs at a temperature of about 64° C. In some embodiments, the dough-kneading occurs at a temperature of about 65° C. In some embodiments, the dough-kneading occurs at a temperature of about 66° C. In some embodiments, the dough-kneading occurs at a temperature of about 67° C. In some embodiments, the dough-kneading occurs at a temperature of about 68° C. In some embodiments, the dough-kneading occurs at a temperature of about 69° C. In some embodiments, the dough-kneading occurs at a temperature of about 70° C. In some embodiments, the dough-kneading occurs at a temperature of about 71° C. In some embodiments, the dough-kneading occurs at a temperature of about 72° C. In some embodiments, the dough-kneading occurs at a temperature of about 73° C. In some embodiments, the dough-kneading occurs at a temperature of about 74° C. In some embodiments, the dough-kneading occurs at a temperature of about 75° C. In some embodiments, the dough-kneading occurs at a temperature of about 76° C. In some embodiments, the dough-kneading occurs at a temperature of about 77° C. In some embodiments, the dough-kneading occurs at a temperature of about 78° C. In some embodiments, the dough-kneading occurs at a temperature of about 79° C. In some embodiments, the dough-kneading occurs at a temperature of about 80° C. In some embodiments, the dough-kneading occurs at a temperature of about 81° C. In some embodiments, the dough-kneading occurs at a temperature of about 82° C. In some embodiments, the dough-kneading occurs at a temperature of about 83° C. In some embodiments, the dough-kneading occurs at a temperature of about 84° C. In some embodiments, the dough-kneading occurs at a temperature of about 85° C. In some embodiments, the dough-kneading occurs at a temperature of about 86° C. In some embodiments, the dough-kneading occurs at a temperature of about 87° C. In some embodiments, the dough-kneading occurs at a temperature of about 88° C. In some embodiments, the dough-kneading occurs at a temperature of about 89° C. In some embodiments, the dough-kneading occurs at a temperature of about 90° C. In some embodiments, the dough-kneading occurs at a temperature of about 91° C. In some embodiments, the dough-kneading occurs at a temperature of about 92° C. In some embodiments, the dough-kneading occurs at a temperature of about 93° C. In some embodiments, the dough-kneading occurs at a temperature of about 94° C. In some embodiments, the dough-kneading occurs at a temperature of about 95° C. In some embodiments, the dough-kneading occurs at a temperature of about 96° C. In some embodiments, the dough-kneading occurs at a temperature of about 97° C. In some embodiments, the dough-kneading occurs at a temperature of about 98° C. In some embodiments, the dough-kneading occurs at a temperature of about 99° C. In some embodiments, the dough-kneading occurs at a temperature of about 100° C. In some embodiments, the dough-kneading occurs at a temperature of about 101° C. In some embodiments, the dough-kneading occurs at a temperature of about 102° C. In some embodiments, the dough-kneading occurs at a temperature of about 103° C. In some embodiments, the dough-kneading occurs at a temperature of about 104° C. In some embodiments, the dough-kneading occurs at a temperature of about 105° C. In some embodiments, the dough-kneading occurs at a temperature of about 106° C. In some embodiments, the dough-kneading occurs at a temperature of about 107° C. In some embodiments, the dough-kneading occurs at a temperature of about 108° C. In some embodiments, the dough-kneading occurs at a temperature of about 109° C. In some embodiments, the dough-kneading occurs at a temperature of about 110° C. In some embodiments, the dough-kneading occurs at a temperature of about 111° C. In some embodiments, the dough-kneading occurs at a temperature of about 112° C. In some embodiments, the dough-kneading occurs at a temperature of about 113° C. In some embodiments, the dough-kneading occurs at a temperature of about 114° C. In some embodiments, the dough-kneading occurs at a temperature of about 115° C. In some embodiments, the dough-kneading occurs at a temperature of about 116° C. In some embodiments, the dough-kneading occurs at a temperature of about 117° C. In some embodiments, the dough-kneading occurs at a temperature of about 118° C.

In some embodiments, the dough-kneading occurs at a temperature of about 119° C. In some embodiments, the dough-kneading occurs at a temperature of about 120° C. In some embodiments, the dough-kneading occurs at a temperature of about 121° C. In some embodiments, the dough-kneading occurs at a temperature of about 122° C. In some embodiments, the dough-kneading occurs at a temperature of about 123° C. In some embodiments, the dough-kneading occurs at a temperature of about 124° C. In some embodiments, the dough-kneading occurs at a temperature of about 125° C. In some embodiments, the dough-kneading occurs at a temperature of about 126° C. In some embodiments, the dough-kneading occurs at a temperature of about 127° C. In some embodiments, the dough-kneading occurs at a temperature of about 128° C. In some embodiments, the dough-kneading occurs at a temperature of about 129° C. In some embodiments, the dough-kneading occurs at a temperature of about 130° C. In some embodiments, the dough-kneading occurs at a temperature of about 131° C. In some embodiments, the dough-kneading occurs at a temperature of about 132° C. In some embodiments, the dough-kneading occurs at a temperature of about 133° C. In some embodiments, the dough-kneading occurs at a temperature of about 134° C. In some embodiments, the dough-kneading occurs at a temperature of about 135° C. In some embodiments, the dough-kneading occurs at a temperature of about 136° C. In some embodiments, the dough-kneading occurs at a temperature of about 137° C. In some embodiments, the dough-kneading occurs at a temperature of about 138° C. In some embodiments, the dough-kneading occurs at a temperature of about 139° C. In some embodiments, the dough-kneading occurs at a temperature of about 140° C. In some embodiments, the dough-kneading occurs at a temperature of about 141° C. In some embodiments, the dough-kneading occurs at a temperature of about 142° C. In some embodiments, the dough-kneading occurs at a temperature of about 143° C. In some embodiments, the dough-kneading occurs at a temperature of about 144° C. In some embodiments, the dough-kneading occurs at a temperature of about 145° C. In some embodiments, the dough-kneading occurs at a temperature of about 146° C. In some embodiments, the dough-kneading occurs at a temperature of about 147° C. In some embodiments, the dough-kneading occurs at a temperature of about 148° C. In some embodiments, the dough-kneading occurs at a temperature of about 149° C. In some embodiments, the dough-kneading occurs at a temperature of about 150° C. In some embodiments, the dough-kneading occurs at a temperature of about 151° C. In some embodiments, the dough-kneading occurs at a temperature of about 152° C. In some embodiments, the dough-kneading occurs at a temperature of about 153° C. In some embodiments, the dough-kneading occurs at a temperature of about 154° C. In some embodiments, the dough-kneading occurs at a temperature of about 155° C. In some embodiments, the dough-kneading occurs at a temperature of about 156° C. In some embodiments, the dough-kneading occurs at a temperature of about 157° C. In some embodiments, the dough-kneading occurs at a temperature of about 158° C. In some embodiments, the dough-kneading occurs at a temperature of about 159° C. In some embodiments, the dough-kneading occurs at a temperature of about 160° C. In some embodiments, the dough-kneading occurs at a temperature of about 161° C. In some embodiments, the dough-kneading occurs at a temperature of about 162° C. In some embodiments, the dough-kneading occurs at a temperature of about 163° C. In some embodiments, the dough-kneading occurs at a temperature of about 164° C. In some embodiments, the dough-kneading occurs at a temperature of about 165° C. In some embodiments, the dough-kneading occurs at a temperature of about 166° C. In some embodiments, the dough-kneading occurs at a temperature of about 167° C. In some embodiments, the dough-kneading occurs at a temperature of about 168° C. In some embodiments, the dough-kneading occurs at a temperature of about 169° C. In some embodiments, the dough-kneading occurs at a temperature of about 170° C. In some embodiments, the dough-kneading occurs at a temperature of about 171° C. In some embodiments, the dough-kneading occurs at a temperature of about 172° C. In some embodiments, the dough-kneading occurs at a temperature of about 173° C. In some embodiments, the dough-kneading occurs at a temperature of about 174° C. In some embodiments, the dough-kneading occurs at a temperature of about 175° C. In some embodiments, the dough-kneading occurs at a temperature of about 176° C. In some embodiments, the dough-kneading occurs at a temperature of about 177° C. In some embodiments, the dough-kneading occurs at a temperature of about 178° C. In some embodiments, the dough-kneading occurs at a temperature of about 179° C. In some embodiments, the dough-kneading occurs at a temperature of about 180° C. In some embodiments, the dough-kneading occurs at a temperature of about 181° C. In some embodiments, the dough-kneading occurs at a temperature of about 182° C. In some embodiments, the dough-kneading occurs at a temperature of about 183° C. In some embodiments, the dough-kneading occurs at a temperature of about 184° C. In some embodiments, the dough-kneading occurs at a temperature of about 185° C. In some embodiments, the dough-kneading occurs at a temperature of about 186° C. In some embodiments, the dough-kneading occurs at a temperature of about 187° C. In some embodiments, the dough-kneading occurs at a temperature of about 188° C. In some embodiments, the dough-kneading occurs at a temperature of about 189° C. In some embodiments, the dough-kneading occurs at a temperature of about 190° C. In some embodiments, the dough-kneading occurs at a temperature of about 191° C. In some embodiments, the dough-kneading occurs at a temperature of about 192° C. In some embodiments, the dough-kneading occurs at a temperature of about 193° C. In some embodiments, the dough-kneading occurs at a temperature of about 194° C. In some embodiments, the dough-kneading occurs at a temperature of about 195° C. In some embodiments, the dough-kneading occurs at a temperature of about 196° C. In some embodiments, the dough-kneading occurs at a temperature of about 197° C. In some embodiments, the dough-kneading occurs at a temperature of about 198° C. In some embodiments, the dough-kneading occurs at a temperature of about 199° C. In some embodiments, the dough-kneading occurs at a temperature of about 200° C.

In some embodiments, including any of the foregoing, the dough-kneading occurs at a temperature of about 21° C. to about 31° C.

In some embodiments, including any of the foregoing, the dough-kneading occurs at a temperature of about 21° C. to about 65° C.

In some embodiments, including any of the foregoing, the dough-kneading occurs at a temperature of about 31° C. to about 65° C.

In some embodiments, including any of the foregoing, the dough-kneading occurs at a temperature of about 31° C. to about 85° C.

In some embodiments, including any of the foregoing, the dough-kneading occurs at a temperature of about 75° C.

In some embodiments, including any of the foregoing, the dough-kneading occurs at a temperature of about 25° C. to about 200° C. In some embodiments, including any of the foregoing, the dough-kneading occurs at a temperature of about 30° C. to about 60° C.

In some embodiments, including any of the foregoing, the dough-kneading occurs at a temperature of about 40° C. to about 80° C. In some embodiments, the dough-kneading occurs at a temperature of about 50° C. to about 100° C. In some embodiments, the dough-kneading occurs at a temperature of about 60° C. to about 120° C. In some embodiments, the dough-kneading occurs at a temperature of about 70° C. to about 140° C. In some embodiments, the dough-kneading occurs at a temperature of about 80° C. to about 160° C. In some embodiments, the dough-kneading occurs at a temperature of about 90° C. to about 180° C. In some embodiments, including any of the foregoing, the dough-kneading occurs at a temperature of about 45° C. In some embodiments, the dough-kneading occurs at a temperature of about 50° C. In some embodiments, the dough-kneading occurs at a temperature of about 55° C. In some embodiments, the dough-kneading occurs at a temperature of about 60° C. In some embodiments, the dough-kneading occurs at a temperature of about 65° C. In some embodiments, the dough-kneading occurs at a temperature of about 70° C. In some embodiments, the dough-kneading occurs at a temperature of about 75° C. In some embodiments, the dough-kneading occurs at a temperature of about 80° C. In some embodiments, the dough-kneading occurs at a temperature of about 85° C. In some embodiments, the dough-kneading occurs at a temperature of about 90° C. In some embodiments, the dough-kneading occurs at a temperature of about 95° C. In some embodiments, the dough-kneading occurs at a temperature of 100° C. In some embodiments, the dough-kneading occurs at a temperature of about 105° C. In some embodiments, the dough-kneading occurs at a temperature of about 110° C. In some embodiments, the dough-kneading occurs at a temperature of about 115° C. In some embodiments, the dough-kneading occurs at a temperature of about 120° C. In some embodiments, the dough-kneading occurs at a temperature of about 125° C. In some embodiments, the dough-kneading occurs at a temperature of about 130° C. In some embodiments, the dough-kneading occurs at a temperature of about 135° C. In some embodiments, the dough-kneading occurs at a temperature of 140° C. In some embodiments, the dough-kneading occurs at a temperature of about 145° C. In some embodiments, the dough-kneading occurs at a temperature of about 150° C. In some embodiments, the dough-kneading occurs at a temperature of about 155° C. In some embodiments, the dough-kneading occurs at a temperature of about 160° C. In some embodiments, the dough-kneading occurs at a temperature of about 165° C. In some embodiments, the dough-kneading occurs at a temperature of about 170° C. In some embodiments, the dough-kneading occurs at a temperature of about 175° C. In some embodiments, the dough- kneading occurs at a temperature of about 180° C. In some embodiments, the dough-kneading occurs at a temperature of about 185° C. In some embodiments, the dough-kneading occurs at a temperature of about 190° C. In some embodiments, the dough-kneading occurs at a temperature of about 195° C. In some embodiments, the dough-kneading occurs at a temperature of about 200° C.

In some embodiments, including any of the foregoing, the dough-kneading occurs at a temperature of about 45° C.

In some embodiments, the method further comprises densifying the electrode by any method used by the skilled artisan. In some embodiments, densifying is by applying high pressure with a uniaxial press. In some embodiments, densifying is by applying high pressure with an isostatic press. In some embodiments, densifying is by calendering the electrode.

In some embodiments, the pressure applied during densifying is from about 400 MPa to 1 GPa (e.g., 400, 450, 500, 550, 600, 650, 700, 750, 800, 850, 900, 950, or 1000 MPa).

In some embodiments, including any of the foregoing, the binder particles are present at 0.3% w/w or less.

In some embodiments, including any of the foregoing, the binder is PTFE.

In some embodiments, including any of the foregoing, the binder is PTFE and at least one additional binder.

In some embodiments, including any of the foregoing, the binder is PTFE and at least one additional binder selected from polyvinylidene fluoride (PVDF), polyvinylidene fluoride hexafluoropropylene (PVDF-HFP), ethylene propylene (EPR), nitrile rubber (NPR), styrene-butadiene-rubber (SBR), polypropylene (PP), polyethylene, atactic polypropylene (aPP), isotactic polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), polyethylene-co-poly (methylene cyclopentane) (PE-co-PMCP), poly (methyl methacrylate) (PMMA) (and other acrylics), acrylic, polyvinylacetacetal resin, polyvinyl butyral resin, PVB, polyvinyl acetal resin, stereoblock polypropylenes, polypropylene polymethylpentene copolymer, polyethylene oxide (PEO), PEO block copolymers, silicone, polyacrylonitrile (PAN), polyvinyl chloride (PVC), polyvinyl pyrrolidone (PVP), polyethylene oxide poly (allyl glycidyl ether) PEO-AGE, polyethylene oxide 2-methoxy ethoxy ethyl glycidyl ether (PEO-MEEGE), polyethylene oxide 2-methoxyethoxyethyl glycidyl poly (allyl glycidyl ether) (PEO-MEEGE-AGE), polysiloxane, polybutadiene polymer, polybutadiene rubber (PB), polyisobutadiene rubber (PIB), polyolefin, alpha-polyolefin, ethylene alpha-polyolefin, polyisoprene rubber (PI), polychloroprene rubber (CR), acrylonitrile-butadiene rubber (NBR), polyethyl acrylate (PEA), and combinations thereof.

In some embodiments, including any of the foregoing, the cathode active material is a material set forth in International Patent Application Publication No. PCT/US2021/049528, filed Sep. 8, 2021, and titled CATHODE COATING, the entire contents of which are herein incorporated by reference in its entirety for all purposes.

In some embodiments, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

In some embodiments, including any of the foregoing, the cathode active material is LiNiₓMn_{y}Co_{z}O₂, x+y+z=1, 03x≤1, 0≤y≤1, and 0≤z≤1 and wherein x+y+z=1.

In some embodiments, including any of the foregoing, the cathode active material is LiNiₓMn_{y}Co_{z}O₂, x is 0.8, y is 0.1, and z is 0.1.

In some embodiments, including any of the foregoing, the cathode active material is LiNiₓMn_{y}Co_{z}O₂, x is 0.6, y is 0.2, and z is 0.2.

In some embodiments, including any of the foregoing, the cathode active material is LiNiₓMn_{y}Co_{z}O₂, x is 0.5, y is 0.3, and z is 0.2.

In some embodiments, including any of the foregoing, the cathode active material is LiNiₓMn_{y}Co_{z}O₂, x is 1/3, y is 1/3, and z is 1/3.

In some embodiments, including any of the foregoing, the cathode active material is LiNiₓMn_{y}Co_{z}O₂.

In some embodiments, including any of the foregoing, the NMC has a d50 particle size, S, of 0.1 μm<S<50 μm.

In some embodiments, including any of the foregoing, the NMC has a d50 particle size, S, of 0.5 μm<S<30 μm.

In some embodiments, including any of the foregoing, the NMC has a d50 particle size, S, of 1 μm<S<20 μm. In some embodiments, including any of the foregoing, the catholyte is LSTPS.

In some embodiments, including any of the foregoing, the catholyte is argyrodite.

In some embodiments, including any of the foregoing, the catholyte is a lithium ion conducting sulfide, e.g., Li₂S-SiS₂.

In some embodiments, including any of the foregoing, the catholyte is a lithium ion conducting oxide, e.g., lithium-stuffed garnet.

In some embodiments, including any of the foregoing, the catholyte is a lithium ion conducting halide, e.g., perovskite.

In some embodiments, including any of the foregoing, the catholyte is a lithium ion conducting organic polymer, e.g., LiPF₆ in PEO.

In some embodiments, including any of the foregoing, the catholyte has a d50 particle size, T, of 0.005 μm<T<20 μm.

In some embodiments, including any of the foregoing, the catholyte has a d50 particle size, T, of 0.01 μm<T<10 μm.

In some embodiments, including any of the foregoing, the catholyte has a d50 particle size, T, of 0.02 μm<T<5 μm.

In some embodiments, including any of the foregoing, the mixture has a density of 2-2.5g/cm³.

In some embodiments, including any of the foregoing, the solvent-free mixture is made by mixing binder particles with cathode active material particles and a catholyte at a temperature less than 0° C.

In some embodiments, PTFE forms fibrils throughout the cathode after cold temperature mixing (e.g., when PTFE is triclinic crystal, which is powdery) and by allowing the PTFE to form fibrils during dough-kneading. In some embodiments, this results in a network of PTFE fiber intermixed with cathode active materials. In some embodiments, above or equal to room temperature, PTFE is hexagonal/pseudohexagonal crystal, which is gummy, tacky, or sticky.

### Process Embodiment A

In some embodiments, a cathode active material (e.g., NMC, 18 g) is mixed with a catholyte (e.g., LSTPS, 3.01g) to form a mixture. The resulting mixture is mixed at room temperature eight times at 20 seconds per time using a blade mixer with a rotating speed of 20,000 rpm.

In some embodiments, a binder (e.g., PTFE, 0.201 g) is added to the mixture to form a second mixture. The second mixture is mixed at −7° C. twice at 10 seconds per time using a blade mixer with a rotating speed of 20,000 rpm.

In some embodiments, the process then includes kneading at room temperature for about thirty minutes.

In some embodiments, the process then includes forming the kneaded mixture into sheet extensions using a sheeter.

### Process Embodiment B

In some embodiments, a cathode active material (e.g., NMC, 18 g) is mixed with a catholyte (e.g., LSTPS, 3.01 g) to form a mixture. The resulting mixture is mixed at room temperature eight times at 20 seconds per time using a blade mixer with a rotating speed of 20,000 rpm.

In some embodiments, a binder (e.g., PTFE, 0.201 g) is added to the mixture to form a second mixture. The second mixture is mixed at room temperature twice at 10 seconds per time using a blade mixer with a rotating speed of 20,000 rpm.

In some embodiments, the process then includes kneading at ˜75° C. for about thirty minutes.

In some embodiments, the process then includes forming the kneaded mixture into sheet extensions using a sheeter.

### Process Embodiment C

In some embodiments, a cathode active material (e.g., NMC, 18 g) is mixed with a catholyte (e.g., LSTPS, 3.01 g) to form a mixture. The resulting mixture is mixed at room temperature eight times at 20 seconds per time using a blade mixer with a rotating speed of 20,000 rpm.

In some embodiments, a binder (e.g., PTFE, 0.201 g) is added to the mixture to form a second mixture. The second mixture was mixed at −7° C. twice at 10 seconds per time using a blade mixer with a rotating speed of 20,000 rpm.

In some embodiments, the process then includes kneading at ˜75° C. for about thirty minutes.

In some embodiments, the process then includes kneading at ˜45° C. for about thirty minutes.

In some embodiments, the process then includes forming the kneaded mixture into sheet extensions using a sheeter.

### Process Embodiment D

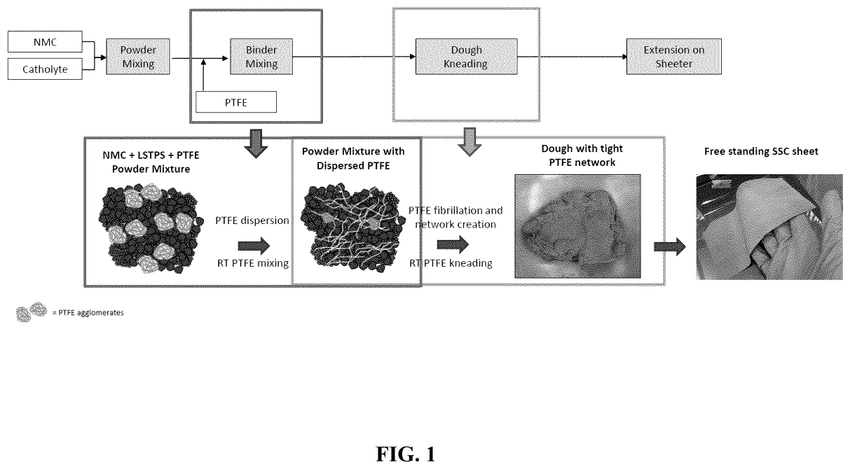

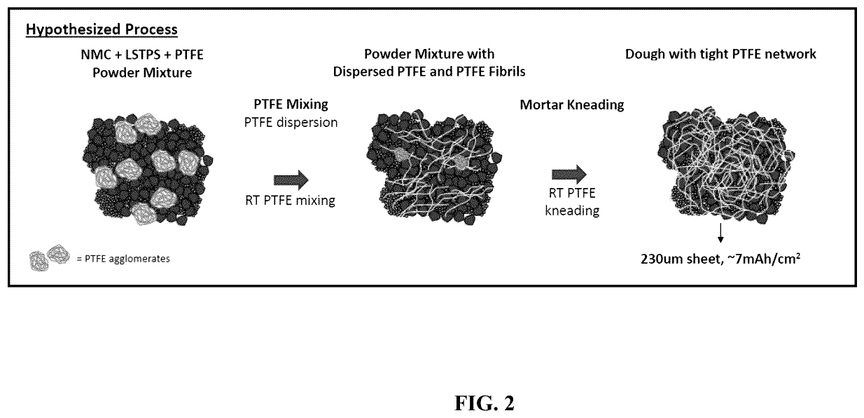

Also set forth herein are the processes illustrated and explained in FIGS. 1 and 2.

FIG. 1 shows an embodiment of a process in which NMC and catholyte materials are mixed with a PTFE binder, subsequently dough-kneaded, and then subsequently made into a sheet extension using a sheeter. A sheeter may also be referred to as an extruder.

FIG. 1 shows PTFE agglomerates mixed with NMC particles.

FIG. 1 shows network creation from the PTFE agglomerates mixed with NMC particles as the PTFE forms fibrils and forms a network in the dough. FIG. 1 shows the dough formed as a sheet.

FIG. 2 shows another embodiment of a process in which NMC and catholyte materials are mixed with a PTFE binder, subsequently dough-kneaded, and then subsequently made into a sheet extension using a sheeter.

### ADDITIONAL EMBODIMENTS

Embodiment 1: A process for making a solid-state cathode (SSC) sheet, comprising: providing, or having provided, a solvent-free mixture comprising cathode active material particles, a catholyte, and binder particles; wherein the binder particles are present at 5 percent by weight (w/w) or less; maintaining the mixture at a temperature from about −30° C. to −5° C., and dough-kneading the mixture to form binder fibrils at a temperature from about 25° C. to 200° C.; and depositing the mixture to form the SSC sheet.

Embodiment 2: The process of embodiment 1, wherein the binder particles are present at 1% w/w or less.

Embodiment 3: The process of embodiment 1 or 2, wherein the binder particles are present at 0.3% w/w or less.

Embodiment 4: The process of any one of embodiments 1-3, comprising maintaining the mixture for 1-4 hours.

Embodiment 5: The process of any one of embodiments 1-4, comprising maintaining the mixture for 2 hours.

Embodiment 6: The process of any one of embodiments 1-5, comprising maintaining the mixture for at −30° C. to −10° C.

Embodiment 7: The process of any one of embodiments 1-6, comprising maintaining the mixture for at −20° C.

Embodiment 8: The process of any one of embodiments 1-7, wherein the dough-kneading the mixture to form binder fibrils comprises shearing the binder particles to form binder fibrils.

Embodiment 9: The process of any one of embodiments 1-8, wherein the temperature of the mixture during the dough-kneading the mixture to form binder fibrils is about 30° C. to about 60° C.

Embodiment 10: The process of any one of embodiments 1-9, wherein the temperature of the mixture during the dough-kneading the mixture to form binder fibrils is about 45° C.

Embodiment 11: The process of any one of embodiments 1-10, wherein the dough-kneading the mixture to form binder fibrils comprises shearing the cathode active material particles.

Embodiment 12: The process of any one of embodiments 1-11, wherein the dough-kneading the mixture to form binder fibrils comprises shearing the catholyte.

Embodiment 13: The process of any one of embodiments 1-12, wherein the cathode active material particles are coated cathode active material particles.

Embodiment 14: The process of any one of embodiments 1-13, wherein the dough-kneading the mixture to form binder fibrils further comprises compressing the cathode active material particles and binder particles.

Embodiment 15: The process of embodiment 14, further comprising creating a network of binder fibrils throughout the cathode active material particles.

Embodiment 16: The process of embodiment 14 or 15, wherein the compressing the cathode active material particles and binder particles is at 10 MPa to 30 MPa of pressure.

Embodiment 17: The process of any one of embodiments 1-16, wherein the dough-kneading the mixture comprises using a mortar.

Embodiment 18: The process of any one of embodiments 1-17, wherein the dough-kneading the mixture comprises using a twin-screw co-rotating extruder.

Embodiment 19: The process of any one of embodiments 1-18, further comprising preprocessing the binder.

Embodiment 20: The process of embodiment 19, wherein preprocessing comprises atomizing the binder.

Embodiment 21: The process of embodiment 20, comprising atomizing the binder using a blade mixer.

Embodiment 22: The process of embodiment 20 or 21, comprising atomizing the binder using a blade mixer at about 15° C.

Embodiment 23: The process of any one of embodiments 1-22, wherein the dough-kneading occurs at a temperature of about 21° C. to about 31° C.

Embodiment 24: The process of any one of embodiments 1-22, wherein the dough-kneading occurs at a temperature of about 21° C. to about 85° C.

Embodiment 25: The process of any one of embodiments 1-22, wherein the dough-kneading occurs at a temperature of about 31° C. to about 85° C.

Embodiment 26: The process of any one of embodiments 1-25, wherein the binder is poly (tetrafluoroethylene) (PTFE).

Embodiment 27: The process of any one of embodiments 1-26, wherein the binder comprises PTFE and further comprises at least one additional binder.

Embodiment 28: The process of any one of embodiments 1-27, wherein the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al₂O₂, wherein x+y+z=1, and 0≤x≤1, 0≤y≤1, and 0≤z≤1.

Embodiment 29: The process of any one of embodiments 1-28, wherein the cathode active material is LiNiₓMn_{y}Co_{z}O₂, x+y+z=1, 0≤x≤1, 0≤y≤1, and 0≤z≤1 and wherein x+y+z=1.

Embodiment 30: The process of embodiment 29, wherein the cathode active material is LiNiₓMn_{y}Co_{z}O₂, x is 0.8, y is 0.1, and z is 0.1.

Embodiment 31: The process of embodiment 29, wherein the cathode active material is LiNiₓMn_{y}Co_{z}O₂, x is 0.6, y is 0.2, and z is 0.2.

Embodiment 32: The process of embodiment 29, wherein the cathode active material is LiNiₓMn_{y}Co_{z}O₂, x is 0.5, y is 0.3, and z is 0.2.

Embodiment 33: The process of embodiment 29, wherein the cathode active material is LiNiₓMn_{y}Co_{z}O₂, x is 1/3, y is 1/3, and z is 1/3.

Embodiment 34: The process of embodiment 29, wherein the cathode active material is Li(NiCoMn)O₂.

Embodiment 35: The process of any one of embodiments 29-34, wherein the cathode active material has a d50 particle size, S, of 0.1 μm≤S≤50 μm.

Embodiment 36: The process of any one of embodiments 29-35, wherein the NMC has a d50 particle size, S, of 0.5 μm≤S≤30 μm.

Embodiment 37: The process of any one of embodiments 29-36, wherein the NMC has a dso particle size, S, of 4 μm≤S<10 μm.

Embodiment 38: The process of any one of embodiments 29-37, wherein the NMC has a d50 particle size, S, of 2 μm≤S<15 μm.

Embodiment 39: The process of any one of embodiments 29-38, wherein the NMC has a d50 particle size, S, of 1 μm≤S≤20 μm.

Embodiment 40: The process of any one of embodiments 29-39, wherein the NMC has a d50 particle size, S, of 4 μm≤S≤20 μm.

Embodiment 41: The process of any one of embodiments 1-40, wherein the catholyte has a d50 particle size, T, of 0.02 μm<T<5 μm.

Embodiment 42: The process of any one of embodiments 1-41, wherein the catholyte has a d50 particle size, T, of 0.05 μm<T<3 μm.

Embodiment 43: The process of any one of embodiments 1-42, wherein the catholyte has a dso particle size, T, of 0.1 μm<T<1.5 μm.

Embodiment 44: The process of any one of embodiments 1-43, wherein the mixture has a density of 2-2.5g/cm³ after the mixture is thinned to a solid-state cathode sheet.

Embodiment 45: The process of any one of embodiments 1-44, wherein the solvent-free mixture is made by mixing binder particles with cathode active material particles and a catholyte at a temperature less than 0° C.

Embodiment 46: The process of any one of embodiments 1-45, comprising calendering the SSC with line pressure that ranges from 0.5 ton/cm to 10 ton/cm.

Embodiment 47: The process of any one of embodiments 1-46, wherein the binder fibrils are less than 1 mm in length.

Embodiment 48: The process of any one of embodiments 1-47, wherein the SSC has a porosity ranging from 40% to 50% by volume (v/v) prior to compressing the cathode active material particles and binder particles.

Embodiment 41: The process of any one of embodiments 1-48, wherein the SSC has a porosity ranging less than 40% v/v prior to compressing the cathode active material particles and binder particles.

Embodiment 50: The process of any one of embodiments 1-49, wherein the SSC has a durometer range of 40-80 prior to compressing the cathode active material particles and binder particles.

Embodiment 51: The process of any one of embodiments 1-50, wherein the SSC has a density of the dough after thinning to sheet of 2-2.5 g/cc.

Embodiment 52: A solid-state cathode made by the process of any one of embodiments 1-51.

Embodiment 53: Embodiment 51: The solid-state cathode of embodiment 52, wherein the average tensile strength is about 0.3 MPa to 0.5 MPa.

Embodiment 54: The solid-state cathode of embodiment 52, wherein the average tensile strength is about 0.45 MPa.

Embodiment 55: The solid-state cathode of embodiment 52, wherein the average Young's modulus is about 0.5 GPa to 0.8 GPa.

Embodiment 56: The solid-state cathode of embodiment 52, wherein the average Young's modulus is about 0.07 GPa.

Embodiment 57: The solid-state cathode of embodiment 52, wherein the average plastic elongation is about 5% to 15%.

Embodiment 58: The solid-state cathode of embodiment 52, wherein the average plastic elongation is about 10%.

Embodiment 59: The solid-state cathode of embodiment 52, wherein the average plastic elongation is about 9%.

Embodiment 601: The solid-state cathode of embodiment 52, wherein the average plastic elongation is about 8%.

Embodiment 61: The solid-state cathode of embodiment 52, wherein the elasticity ranges from 0.01-0.15 GPa. In these embodiments, the solid-state cathode sheet is less than 1 mm in thickness. In some of these embodiments, the solid-state cathode sheet is at least 100 nm in thickness. In some of these embodiments, the solid-state cathode sheet is at least 250 nm in thickness. In some of these embodiments, the solid-state cathode sheet is at least 500 nm in thickness. In some of these embodiments, the solid-state cathode sheet is at least 1 μm in thickness.

Embodiment 62: A composition comprising cathode active material particles; a binder present at 1% w/w or less; wherein the binder is mixed with the cathode active material particles; the binder is present as fibrils; and the composition is solvent-free.

Embodiment 63: The composition of embodiment 62, wherein the binder is present at 0.3% w/w or less.

Embodiment 64: The composition of embodiment 62 or 63, wherein the binder is PTFE.

Embodiment 65: The composition of any one of embodiments 62-64, wherein the binder comprises PTFE and further comprises at least one additional binder. In some embodiments, the additional binder is selected from the group consisting of polypropylene (PP), polyethylene, atactic polypropylene (aPP), isotactic polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), polyethylene-co-poly (methylene cyclopentane) (PE-co-PMCP), poly (methyl methacrylate) (and other acrylics), acrylic, polyvinylacetacetal resin, polyvinyl butyral resin, PVB, polyvinyl acetal resin, stereoblock polypropylenes, polypropylene polymethylpentene copolymer, polyethylene oxide (PEO), PEO block copolymers, silicone, and the like. In some examples, including any of the foregoing, the binder is a polymer is selected from the group consisting of polyacrylonitrile (PAN), polypropylene, polyethylene, polyethylene oxide (PEO), poly methyl methacrylate (PMMA), polyvinyl chloride (PVC), polyvinyl pyrrolidone (PVP), polyethylene oxide poly (allyl glycidyl ether) PEO-AGE, polyethylene oxide 2-methoxy ethoxy ethyl glycidyl ether (PEO-MEEGE), polyethylene oxide 2-methoxyethoxyethyl glycidyl poly (allyl glycidyl ether) (PEO-MEEGE-AGE), polysiloxane, polyvinylidene fluoride (PVDF), polyvinylidene fluoride hexafluoropropylene (PVDF-HFP), ethylene propylene (EPR), nitrile rubber (NPR), styrene-butadiene-rubber (SBR), polybutadiene polymer, polybutadiene rubber (PB), polyisobutadiene rubber (PIB), polyolefin, alpha-polyolefin, ethylene alpha-polyolefin, polyisoprene rubber (PI), polychloroprene rubber (CR), acrylonitrile-butadiene rubber (NBR), and polyethyl acrylate (PEA).

Embodiment 66: The composition of any one of embodiments 62-65, wherein the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al₂O₂, wherein x+y+z=1, and 0≤x≤1, 0≤y≤1, and 0≤z≤1.

Embodiment 67: The composition of any one of embodiments 62-66, wherein the cathode active material is LiNiₓMn_{y}Co_{z}O₂, x+y+z=1, 05x≤1, 0≤y≤1, and 0≤z≤1 and wherein x+y+z=1.

Embodiment 68: The composition of embodiment 67, wherein the cathode active material is LiNiₓMn_{y}Co_{z}O₂, x is 0.8, y is 0.1, and z is 0.1.

Embodiment 69: The composition of embodiment 67, wherein the cathode active material is LiNiₓMn_{y}Co_{z}O₂, x is 0.6, y is 0.2, and z is 0.2.

Embodiment 70: The composition of embodiment 67, wherein the cathode active material is LiNiₓMn_{y}Co_{z}O₂, x is 0.5, y is 0.3, and z is 0.2.

Embodiment 71: The composition of embodiment 67, wherein the cathode active material is LiNiₓMn_{y}Co_{z}O₂, x is 1/3, y is 1/3, and z is 1/3.

Embodiment 72: The composition of embodiment 67, wherein the cathode active material is Li(NiCoMn)O₂.

Embodiment 73: The composition of any one of embodiments 67-72, wherein the NMC has a d50 particle size, S, of 0.5 μm≤S≤30 μm.

Embodiment 74: The composition of any one of embodiments 67-73, wherein the NMC has a d50 particle size, S, of 1 μm<S<20 μm.

Embodiment 75: The composition of any one of embodiments 67-74, wherein the NMC has a d50 particle size, S, of 4 μm<S<20 μm.

Embodiment 76: The composition of any one of embodiments 67-75, wherein the NMC has a d50 particle size, S, of 2 μm<S<15 μm.

Embodiment 77: The composition of any one of embodiments 67-76, wherein the NMC has a d50 particle size, S, of 4 μm<S<10 μm.

Embodiment 78: The composition of any one of embodiments 67-77, wherein the catholyte has a dso particle size, T, of 0.02 μm<T<5 μm.

Embodiment 79: The composition of any one of embodiments 67-78, wherein the catholyte has a d50 particle size, T, of 0.05 μm<T<3 μm.

Embodiment 80: The composition of any one of embodiments 62-79, further comprising a catholyte, wherein the catholyte has a d50 particle size, T, of 0.02 μm<T<5 μm.

Embodiment 81: The composition of any one of embodiments 62-80, further comprising a catholyte, wherein the catholyte has a d50 particle size, T, of 0.05 μm<T<3 μm.

Embodiment 82: The composition of any one of embodiments 62-81, further comprising a catholyte, wherein the catholyte has a d50 particle size, T, of 0.1 μm<T<1.5 μm.

Embodiment 83: The composition of any one of embodiments 36-82, wherein the composition has a density of 2-2.5g/cm³.

Embodiment 84: A thin sheet comprising the composition of any one of embodiments 62-83.

Embodiment 85: The thin sheet of embodiment 84, wherein the porosity is less than 40% v/v.

Embodiment 86: The thin sheet of embodiment 84, wherein the cathode active loading is between 1 and 15 mAh/cm².

Embodiment 87: The thin sheet of embodiment 84, wherein the cathode active loading is between at least 5 mAh/cm².

Embodiment 88: The thin sheet of any one of embodiments 84-87, wherein the sheet has a thickness of 120 μm.

Embodiment 89: The thin sheet of any one of embodiments 84-88, wherein the sheet has a thickness of 150 μm.

Embodiment 90: The thin sheet of any one of embodiments 84-89, wherein the sheet is at least 5 centimeter (cm) in width.

Embodiment 91: The thin sheet of any one of embodiments 84-90, wherein the sheet is at least 1 meter (m) in width.

Embodiment 92: The thin sheet of any one of embodiments 84-91, wherein the sheet is at least 10 cm in length.

Embodiment 93: The thin sheet of any one of embodiments 84-92, wherein the sheet is at least 70 cm in length.

Embodiment 94: The thin sheet of any one of embodiments 84-93, wherein the sheet is at least 1 m in length.

Embodiment 95: A bilayer comprising a metal layer in contact with a thin sheet of any one of embodiments 62-94.

Embodiment 96: A trilayer comprising a metal layer between and in contact with two thin sheets of any one of embodiments 84-94.

Embodiment 97: The bilayer or trilayer of any one of embodiments 94-96, wherein the metal layer is a layer of Al.

Embodiment 98: The bilayer or trilayer of any one of embodiments 94-96, wherein the metal layer is a layer of Ni.

Embodiment 99: The bilayer or trilayer of any one of embodiments 94-96, wherein the metal layer is a layer of Cu, Ni, Al, Mg, Ag, Au, Pt, or a combination thereof.

Embodiment 100: A bilayer comprising a solid-state electrolyte layer in contact with a thin sheet of any one of embodiments 84-94.

Embodiment 101: A trilayer comprising a solid-state electrolyte layer between and in contact with two thin sheets of any one of embodiments 84-94.

Embodiment 102: The bilayer or trilayer of any one of embodiments 100-101, wherein the solid-state electrolyte layer is a layer of lithium-stuffed garnet.

In some embodiments, set forth herein is a process for making a solid-state cathode (SSC) sheet, comprising: providing, or having provided, a solvent-free mixture comprising cathode active material particles, a catholyte, and binder particles; wherein the binder particles are present at 5 percent by weight (w/w) or less; maintaining the mixture at a temperature from about −30° C. to −5° C.; dough-kneading the mixture to form binder fibrils at a temperature from about 25° C. to 200° C.; and depositing the mixture to form an SSC sheet; thereby making an SSC sheet.

In some embodiments, including any of the foregoing, the process includes mixing the cathode active material particles, catholyte, and binder particles before maintaining the mixture.

In some embodiments, including any of the foregoing, the process includes mixing the mixture while maintaining the mixture at the temperature from about −30° C. to −5° C.

In some embodiments, including any of the foregoing, the binder particles are present at 1% w/w or less.

In some embodiments, including any of the foregoing, the process includes maintaining the mixture for 1 hours to 4 hours.

In some embodiments, including any of the foregoing, the process includes maintaining the mixture at a temperature from −30° C. to −10° C.

In some embodiments, including any of the foregoing, the dough-kneading the mixture to form binder fibrils comprises shearing the binder particles to form binder fibrils.

In some embodiments, including any of the foregoing, the temperature of the mixture during the dough-kneading the mixture to form binder fibrils is from about 30° C. to about 60° C.

In some embodiments, including any of the foregoing, the dough-kneading the mixture to form binder fibrils comprises shearing the catholyte.

In some embodiments, including any of the foregoing, the cathode active material particles are coated cathode active material particles.

In some embodiments, including any of the foregoing, the dough-kneading the mixture to form binder fibrils further comprises compressing the cathode active material particles and binder particles.

In some embodiments, including any of the foregoing, the cathode active material particles and binder particles is at 10 MPa to 30 MPa of pressure.

In some embodiments, including any of the foregoing, the binder is poly (tetrafluoroethylene) (PTFE).

In some embodiments, including any of the foregoing, the binder comprises PTFE and further comprises at least one additional binder.

In some embodiments, including any of the foregoing, the cathode active material is LiNiₓMn_{y}Co_{z}O₂, x+y+z=1, 0x≤1, 0≤y≤1, and 0≤z≤1 and wherein x+y+z=1.

In some embodiments, including any of the foregoing, the cathode active material has a d50 particle size, S, of 2 μm≤S<15 μm.

In some embodiments, including any of the foregoing, the SSC further comprises a catholyte and the catholyte has a d50 particle size, T, of 0.02 μm<T<5 μm.

In some embodiments, including any of the foregoing, the SSC sheet has a density of 2-2.5g/cm³.

In some embodiments, including any of the foregoing, the process includes calendering the SSC with line pressure that ranges from 0.5 ton/cm to 10 ton/cm.

In some embodiments, including any of the foregoing, the binder fibrils are less than 1 mm in length.

In some embodiments, including any of the foregoing, the SSC has a porosity ranging from 40% to 50% by volume (v/v) prior to compressing the cathode active material particles and binder particles.

In some embodiments, including any of the foregoing, the SSC has a porosity ranging less than 40% v/v after compressing the cathode active material particles and binder particles.

In some embodiments, including any of the foregoing, the mixture to form binder fibrils occurs at a temperature from about 35° C. to 100° C.

In some embodiments, including any of the foregoing, the mixture to form binder fibrils occurs at a temperature from about 35° C. to 75° C.

In some embodiments, including any of the foregoing, the dough-kneading the mixture to form binder fibrils occurs at a temperature from about 35° C. to 50° C.

In some embodiments, set forth herein is a solid-state cathode sheet made by a process herein.

In some embodiments, including any of the foregoing, the solid-state cathode sheet has an average tensile strength that is about 0.3 MPa to about 0.5 MPa.

In some embodiments, including any of the foregoing, the solid-state cathode sheet has an average Young's modulus that is about 0.5 GPa to about 0.8 GPa.

In some embodiments, including any of the foregoing, the solid-state cathode sheet has an average plastic elongation that is about 5% to about 15%.

In some embodiments, including any of the foregoing, the solid-state cathode sheet has an elasticity that is about 0.01 GPa to about 0.15GPa. In some embodiments, elasticity may be affected by modifying the dispersion of binder (e.g., PTFE). In some embodiments, elasticity may be affected by modifying the kneading process.

In some embodiments, set forth herein is a composition comprising: cathode active material particles; a binder present at 1% w/w or less; wherein: the binder is mixed with the cathode active material particles; the binder is present as fibrils; and the composition is solvent-free.

In some embodiments, including any of the foregoing, the composition further includes a catholyte.

In some embodiments, including any of the foregoing, the binder is poly (tetrafluoroethylene) (PTFE).

In some embodiments, including any of the foregoing, the binder comprises PTFE and further comprises at least one additional binder.

In some embodiments, including any of the foregoing, the cathode active material is LiNiₓMn_{y}Co_{z}O₂, x+y+z=1, 03x≤1, 0≤y≤1, and 0≤z≤1 and wherein x+y+z=1.

In some embodiments, including any of the foregoing, the NMC has a d50 particle size, S, of 2 μm≤S<15 μm.

In some embodiments, including any of the foregoing, the catholyte has a d50 particle size, T, of 0.02 μm<T<5 μm.

In some embodiments, including any of the foregoing, the composition has a density of 2-2.5g/cm³ when formed as a sheet.

In some embodiments, including any of the foregoing, the binder fibrils are less than 1 mm in length.

In some embodiments, including any of the foregoing, the SSC has a porosity ranging less than 40% v/v.

In some embodiments, set forth herein is a thin sheet comprising a composition set forth herein.

In some embodiments, set forth herein is a bilayer comprising a metal layer in contact with a thin sheet set forth herein.

In some embodiments, set forth herein is a trilayer comprising a metal layer between and in contact with two thin sheets set forth herein.

In some embodiments, including any of the foregoing, the metal layer is a layer of Al, Ni, Cu, Ni, Al, Mg, Ag, Au, Pt, or a combination thereof.

In some embodiments, set forth herein is a bilayer comprising a solid-state electrolyte layer in contact with a thin sheet set forth herein.

In some embodiments, set forth herein is a trilayer comprising a solid-state electrolyte layer between and in contact with two thin sheets set forth herein.

In some embodiments, including any of the foregoing, the solid-state electrolyte layer is a layer of lithium-stuffed garnet.

### EXAMPLES

Reagents, chemicals, and materials were commercially purchased unless specified otherwise to the contrary.

Pouch cell containers were purchased from Showa Denko. The Electrochemical potentiostat used was an Arbin potentiostat.

Electrical impedance spectroscopy (EIS) was performed with a Biologic VMP3, VSP, VSP-300, SP-150, or SP-200 .

Electron microscopy was performed in a FEI Quanta SEM, a Helios 600i, or a Helios 660 FIB-SEM.

Transmission Electron microscopy was performed as follows.

Sample preparation: The samples for TEM measurements were prepared using Ga ion sourced focused ion beam (nanoDUE'T NB5000, Hitachi High-Technologies). To protect the surface of material from the Ga ion beam, multiple protective layers were deposited in advance to the sampling; at first, metal layer was deposited by plasma coater and then carbon protective layer and tungsten layer were deposited by high vacuum evaporation and focused ion beam, respectively. The thin slice sampling was conducted by focused ion beam. The prepared sample was measured in TEM.

TEM measurement: TEM images of coated NMC were obtained by field emission electron microscope (JEM-2100F, JEOL). The Acceleration voltage was set to 200 kV. The electron beam radius was set to about 0.7 to 1 nm.

X-ray powder diffraction (XRD) was performed in a Bruker D8 Advance A25 with Cu K-α radiation at room temperature (e.g., between 21° C. and 23° C.). Source is Cu-Ka, wavelength at 1.54 Å. X-ray at 40·kV and 25 mA. Detector: LYNXEYE_XE with PSD opening 2.843. Divergence slit at 0.6 mm and antiscatter at 5.0 mm fixed.

Milling was performed using a Retsch PM 400 Planetary Ball Mill. Mixing was performed using a Fischer Scientific vortex mixer, a Flaktek speed mixer, or a Primix filmix homogenizer.

Casting was performed on a TQC drawdown table. Calendering was performed on an IMC calender.

Light scattering was performed on a Horiba, model: Partica, Model No.: LA-950V2, general term: laser scattering particle size distribution analyzer.

The Lithium Nickel Cobalt Manganese Oxide (NMC) used in the Examples was LiNi_{0.85}Co_{0.1}Mn_{0.05}O₂ unless specified otherwise.

### Example 1—Making A Solid-State Cathode Sheet

Step 1:1 8 g of NMC was mixed with 3.01 g of LSTPS. The resulting mixture was mixed at room temperature eight times at 20 seconds per time using a blade mixer with a rotating speed of 20,000 rpm. The Li₁₀Si_{0.5}Sn_{0.5}P₂S₁₂ (hereinafter “LSTPS”) was wet milled to produce LSTPS particles having a dso particle diameter of about 50 nm to 500 nm. See U.S. Pat. Nos. 9,172,114 and 10,535,878, which are herein incorporated by reference in their entirety for all purposes.
Step 2: 0.201 g PTFE was added to the mixture.
Step 3: The resulting mixture was mixed at room temperature twice at 10seconds per time using a blade mixer with a rotating speed of 20,000 rpm.
Step 4: The resulting mixture was dough-kneaded at room temperature.
Step 5: The resulting mixture was formed into sheet extensions using a sheeter. The use of the term sheeter herein is synonymous with the term extruder.

### Example 2-Analyzing A Solid-State Cathode Sheet

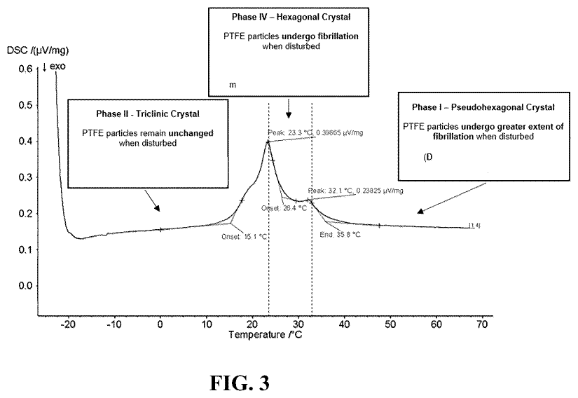

Differential scanning calorimetry was used to analyze the PTFE fibrillation process. See FIG. 3. FIG. 3 shows that there are benefits to PTFE being dispersed at lower temperature than the phase transition temperature from the triclinic phase to the hexagonal phase. In this example, the phase transition temperature was 15° C. FIG. 3 shows that there are benefits to kneading at temperature above the phase transition temperature.

DSC was measured for PTFE, alone, to see the phase transition temperature. FIG. 3 shows that mixing of the PTFE may need to happen at the temperature and below the exothermic peak; and kneading should happen after the onset of exothermic peak.

Differential scanning calorimetry was performed using a STA 449 F3 Jupiter, Netzsch system, scanning between (−10° C.) and (70° C.) at a scan rate of 2° C./min using closed Au-plated SS pan which was sealed under dry air atmosphere (dew point=−50° C.).

### Example 3: Cycle Testing

A solid electrolyte was prepared: Lithium sulfide (Li₂S), phosphorus pentasulfide (P₂S₅), and lithium iodide (LiI) were mixed in a predetermined ratio. In one sample, lithium sulfide (Li₂S), phosphorus pentasulfide (P₂S₅), and lithium iodide (LiI) were mixed. The molar ratio of LiI:Li₂S:P₂S₅ was (3 to 4):(0.1 to 1):(0.5 to 1.5). The mixture was placed in a 500 ml zirconia milling jar with 1 mm zirconia milling media at a milling media: powder mass ratio of >7.5. The mixture was agitated in a planetary mill (Retsch PM400, 150 mm revolution radius, 1:2 speed ratio) for sixteen to thirty-six 16-32 hours.

An all-solid-state battery was made using a solid-state cathode as made in Example 1 and a separator which was made of the solid electrolyte in the preceding paragraph.

The cathode layer and separator were pressed at 700 MPa to densify the two into a pellet type battery. An aluminum current collector was used adjacent to the cathode layer. A nickel current collector was used adjacent to an anode layer. Finally, the stack of pellet and current collectors were vacuum sealed in a Mylar bag as a battery cell. The anode layer was made up of lithium metal. Metallic lithium as an anode was plated when the battery cell was charged. The cathode layer was a solid-state sheet that was 100 μm-150 μm thick. The solid-state separator layer was 30 μm-50 μm thick.

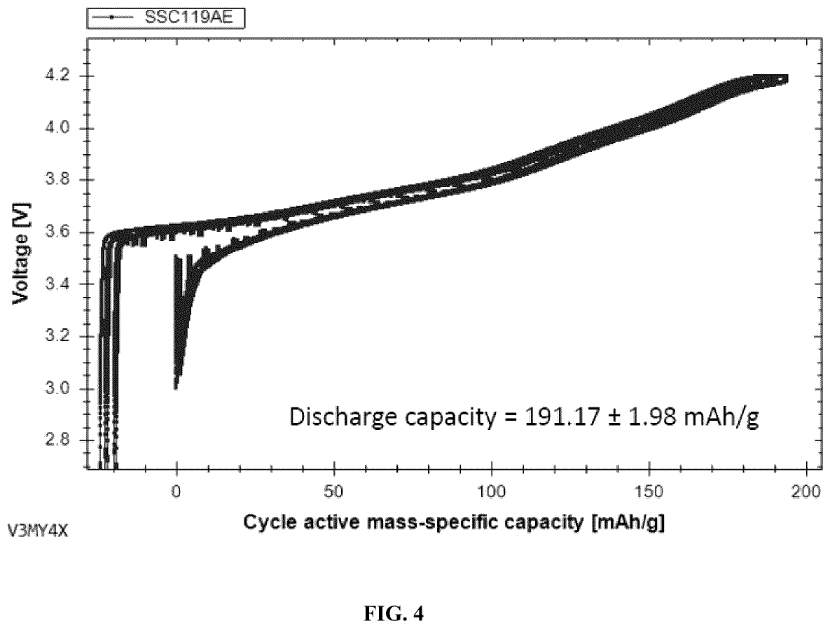

The battery was cycled. The results are shown in FIG. 4.

### Example 4: Area-Specific Resistance (ASR) Testing

A solid electrolyte was prepared: Lithium sulfide (Li₂S), phosphorus pentasulfide (P₂S₅), and lithium iodide (LiI) were mixed in a predetermined ratio. In one sample, lithium sulfide (Li₂S), phosphorus pentasulfide (P₂S₅), and lithium iodide (LiI) were mixed. The molar ratio of LiI:Li₂S:P₂S₅ was (3 to 4):(0.1 to 1):(0.5 to 1.5). The mixture was placed in a 500 ml zirconia milling jar with 1 mm zirconia milling media at a milling media: powder mass ratio of >7.5. The mixture was agitated in a planetary mill (Retsch PM400, 150 mm revolution radius, 1:2 speed ratio) for sixteen to thirty-two (16-32) hours.

An all-solid-state battery was made using a solid-state cathode as made in Example 1 and a separator which was made of the solid electrolyte as prepared in the preceding paragraph. The cathode layer was a solid-share sheet that was 100 μm-150 μm thick. The solid-state separator layer was 30 μm-50 μm thick.

The cathode layer and separator were pressed at 700 MPa to densify the two into a pellet type battery. An aluminum current collector was used adjacent to the cathode layer. A nickel current collector was used adjacent to an anode layer. Finally, the stack of pellet and current collectors are vacuum sealed in Mylar bag to be a battery cell. The anode layer was made up of lithium metal. Metallic lithium as an anode was plated when the battery cell was charged.

Battery cells were charged and discharged at 30° C. at the intermittent current pulse with constant current density of 0.55 mA/cm² (C/10 rate) and within the operation voltage of 3 V to 4.25 V. The current pulse was applied for 9 minutes, the current was stopped, and the system was relaxed for 3 minutes. This intermittent pulse was repeated until the cell voltage reached to 4.25V during charging and 3V during discharging. The area-specific resistance (ASR) of the battery cells was obtained by reading voltage drop during relaxation steps during discharging. The obtained ASR was named as R₁.

After cycling at 30° C., the battery cells were again charged to 4.25V with a current density of 1.7 mA/cm². The temperature of the cells was then raised to 60° C. After the temperature stabilized at 60° C., the battery cells were held at 4.25V for 7 days and the cells were discharged to 3V.

The temperature of the battery cells was lowered to 30° C. The battery cells were charged and discharged between 3 V and 4.25 V and at a current density of 1.7 mA/cm². From this, an ASR (R₂) was determined.

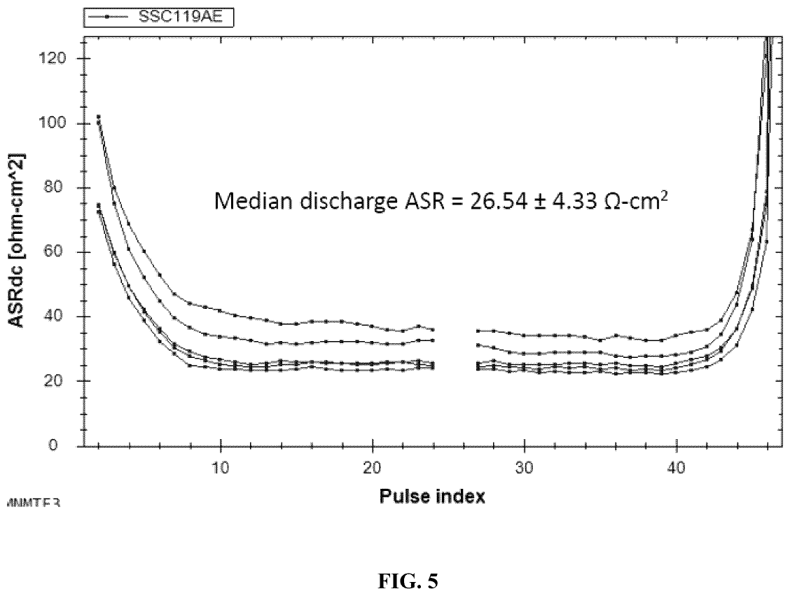

The stability was evaluated by ΔR=R₂−R₁. The results are shown in FIG. 5.

### Example 5: Tensile Strength Testing

An all-solid-state cathode sheet was made as in Example 1 using an extruder.

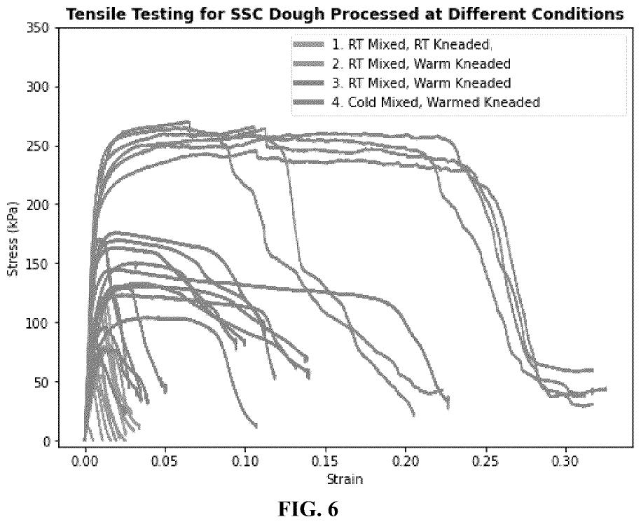

The tensile strength of the cathode sheet as a function of strain was tested for a series of samples. The results are shown in FIG. 6.

An Instron mechanical tester with 100N load cell and pneumatic side action grips for conducting tensile testing was used. The testing rate was 1 m/min. The difference between the two groups of samples was the dough process procedures. A higher strength and ductility are observed which shows the importance of cold PTFE dispersion and warm dough kneading.

### Example 6—Making A Solid-State Cathode Sheet

Step 1:18 g of NMC was mixed with 3.01 g of Li₁₀Si_{0.5}Sn_{0.5}P₂S₁₂ (hereinafter “LSTPS”). The resulting mixture was mixed at room temperature eight times at 20 seconds per time using a blade mixer with a rotating speed of 20,000 rpm. The LSTPS was wet milled as per Example 1 to produce LSTPS particles having a ₅₀ particle diameter of about 50 nm to 500 nm.
Step 2:0.201 g PTFE was added to the mixture. The PTFE had a PTFE powder size of 1 μm with particles of PTFE smaller than 1 μm.
Step 3: The resulting mixture was stabilized at around −20° C. for at least 2 hours. The stabilized mixture was then mixed 10 times at 2 seconds per time using a blade mixer with a rotating speed of 20,000 rpm. Between each time of mixing, the mixture was returned to a-20° C. environment and stabilized for 2 minutes.
Step 4: The resulting mixture was moved out of the −20° C. environment. Fibrillation was then conducted in a kneader at 45° C.
Step 5: The resulting mixture was formed into sheet extensions using a sheeter. The sheet is also referred to as an extruder.
Step 6: The sheets were densified at high pressure by calendering. The calendering had a line pressure between 0.5 ton/cm to 10 ton/cm.

### Example 7—Comparison of Cathode Preparations

Three groups of exemplary cathodes were prepared by the method in Example 6, with modifications as discussed below. The three groups of exemplary cathodes groups were prepared by varying the conditions in steps 3 and 4 in Example 6 as follows.

Group 1 was prepared by mixing the stabilized mixture 10 times at 2 seconds per time using a blade mixer with a rotating speed of 20,000 rpm at −30° C. The sample was stabilized frequently during the mixing process. After mixing at −30° C., fibrillation was then conducted in a kneader at 160° C.

Group 2 was prepared by mixing the stabilized mixture 10 times at 2 seconds per time using a blade mixer with a rotating speed of 20,000 rpm at temperatures ranging from −20° C. to 0° C. After mixing at −20° C. to 0° C., fibrillation was then conducted in a kneader at 45° C.

Group 3 was prepared by mixing the stabilized mixture 10 times at 2 seconds per time using a blade mixer with a rotating speed of 20,000 rpm at room temperature. After mixing at −20° C. to 0° C., fibrillation was then conducted in a kneader at room temperature.

For the three groups of samples, the properties of the solid-state cathode sheet made by Example 6 and detailed herein and deposited as a sheet were the following:
Average tensile strength for each group:
   Group 1=0.84 MPa,
   Group 2=0.44 MPa,
   Group 3=0.18 MPa.
Average modulus of each group:
   Group 1=0.10 GPa,
   Group 2=0.07 GPa,
   Group 3=0.02 GPa.
Average plastic elongation for each group:
   Group 1=18%,
   Group 2=8.7%,
   Group 3=1.7%.

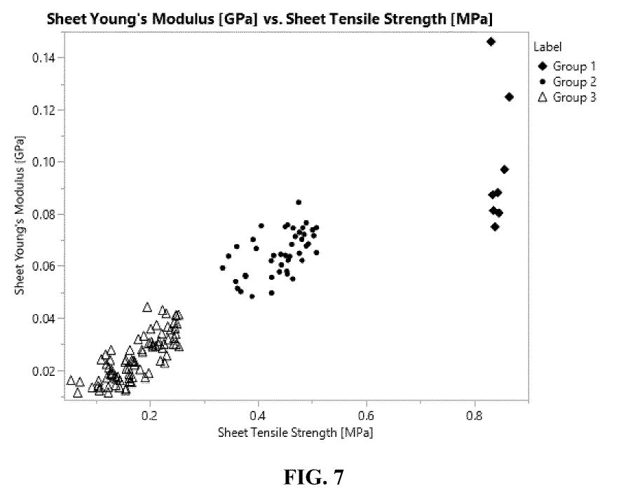

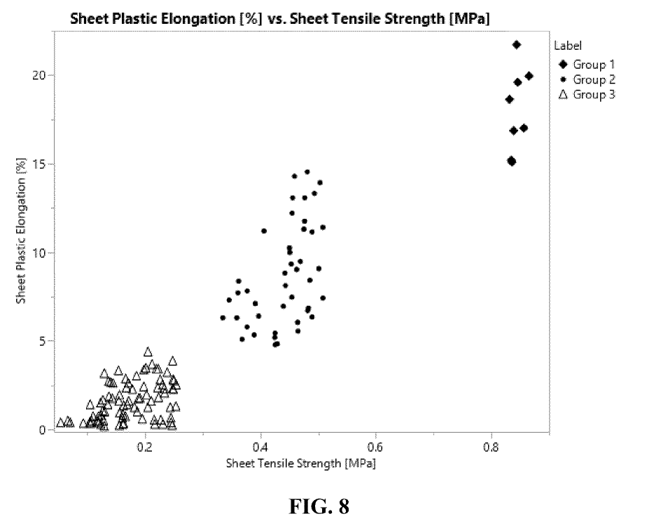

The properties of the samples are shown in FIGS. 7 and 8.

Tensile strength was measured using an Instron mechanical tester with 100N load cell and pneumatic side action grips for conducting tensile testing. The testing rate was 1 m/min.

An uncontrolled PTFE dispersion/kneading temperature may lead to soft, weak, and brittle SSC sheets that are difficult to handle.

Cold PTFE dispersion and hot SSC kneading results in SSC sheets were significantly stronger, stiffer, and more ductile. This is shown by the cluster in the middle of FIGS. 9 and 10 and identified as Group 2. Group 2, as noted above and herein, was surprisingly advantageous with regard to its average tensile strength, average modulus, and average plastic elongation.

In some cases when sheets are too stiff and strong, as with Group 3, this may cause difficulty in sheet thinning process. Challenges also exist when the sheets are brittle and weak as in Group 1.

The results suggest that plastic elongation is an important feature, as the least desirable product will be a brittle SSC dough sheet. This will be associated with low plastic elongation. If a material's tensile strength and modulus are too high, the SSC thinning process will be more difficult. For example, the dough may be too stiff and, or, rigid.

The embodiments and examples described above are intended to be merely illustrative and non-limiting. Those skilled in the art will recognize or will be able to ascertain using no more than routine experimentation, numerous equivalents of specific compounds, materials, and procedures. All such equivalents are considered to be within the scope of and are encompassed by the appended claims.

1. A process for making a solid-state cathode (SSC) sheet, comprising:
providing, or having provided, a solvent-free mixture comprising cathode active material particles, a catholyte, and binder particles;
wherein the binder particles are present at 5 percent by weight (w/w) or less;
maintaining the mixture at a temperature from about −30° C. to −5° C.;
dough-kneading the mixture to form binder fibrils at a temperature from about 25° C. to 200° C.; and
depositing the mixture to form an SSC sheet;
thereby making an SSC sheet.

2. The process of claim 1, further comprising mixing the cathode active material particles, catholyte, and binder particles before maintaining the mixture.

3.-6. (canceled)

7. The process of claim 1, wherein the dough-kneading the mixture to form binder fibrils comprises shearing the binder particles to form binder fibrils.

8. (canceled)

9. The process of claim 1, wherein the dough-kneading the mixture to form binder fibrils comprises shearing the catholyte.

10. (canceled)

11. The process of claim 1, wherein the dough-kneading the mixture to form binder fibrils further comprises compressing the cathode active material particles and binder particles.

12. The process of claim 11, wherein the compressing the cathode active material particles and binder particles is at 10 MPa to 30 MPa of pressure.

13. The process of claim 1, wherein the binder is poly (tetrafluoroethylene) (PTFE).

14.-18. (canceled)

19. The process of claim 1, comprising calendering the SSC with line pressure that ranges from 0.5 ton/cm to 10 ton/cm.

20. The process of claim 1, wherein the binder fibrils are less than 1 mm in length.

21. The process of claim 1, wherein the SSC has a porosity ranging from 40% to 50% by volume (v/v) prior to compressing the cathode active material particles and binder particles.

22.-25. (canceled)

26. A solid-state cathode sheet made by the process of claim 1.

27. The solid-state cathode sheet of claim 26, wherein the average tensile strength is about 0.3 MPa to about 0.5 MPa.

28. The solid-state cathode sheet of claim 26, wherein the average Young's modulus is about 0.5 GPa to about 0.8 GPa.

29.-30. (canceled)

31. A composition comprising:
cathode active material particles;
a binder present at 1% w/w or less;
wherein:
the binder is mixed with the cathode active material particles;
the binder is present as fibrils; and
the composition is solvent-free.

32. The composition of claim 31, further comprising a catholyte.

33. The composition of claim 31, wherein the binder is poly (tetrafluoroethylene) (PTFE).

34. (canceled)

35. The composition of claim 31, wherein the cathode active material is LiNiₓMn_{y}Co_{z}O₂, x+y+z=1, 0<x<1, 0<z<1, and 0<z<1 and wherein x+y+z=1.

36.-37. (canceled)

38. The composition of claim 31, wherein the composition has a density of 2-2.5g/cm³ when formed as a sheet.

39. The composition of claim 31, wherein the binder fibrils are less than 1 mm in length.

40. The composition of claim 31, wherein the SSC has a porosity ranging less than 40% v/v.

41.-47. (canceled)
